(19) United States
(12) Patent Application Publication
(10) Pub. No.: US 2012/0019528 A1
(43) Pub. Date: Jan. 26, 2012

(54) DISPLAY APPARATUS, DISPLAY METHOD, AND COMPUTER-READABLE RECORDING MEDIUM

(75) Inventors: Akira Ugawa, Tokyo (JP); Osamu Nonaka, Sagamihara-shi (JP)

(73) Assignee: OLYMPUS IMAGING CORP., Tokyo (JP)

(21) Appl. No.: 13/189,895

(22) Filed: Jul. 25, 2011

(30) Foreign Application Priority Data
Jul. 26, 2010 (JP) 2010-167473
Jul. 29, 2010 (JP) 2010-171148
Aug. 17, 2010 (JP) 2010-182558

(51) Int. Cl. G06T 15/00; G09G 5/00

(52) U.S. Cl. 345/419; 345/629

(57) ABSTRACT

A display apparatus includes a display unit that displays a three-dimensional image generated by combining two pieces of image data; an area selecting-setting unit that selects an adjustment area in which an offset distance, which is a virtual distance from a display screen of the display unit in a direction perpendicular to the display screen in the three-dimensional image, is adjusted; an input unit that receives a change instruction signal for giving an instruction to change the offset distance in the adjustment area; an offset-distance adjustment unit that adjusts the offset distance in the adjustment area in accordance with the change instruction signal; and a display controller that causes the display unit to display a three-dimensional image by using the two pieces of image data in which the offset distance in the adjustment area is adjusted.

### CROSS-REFERENCE TO RELATED APPLICATIONS

This application is based upon and claims the benefit of priority from Japanese Patent Application No. 2010-167473, filed on Jul. 26, 2010; Japanese Patent Application No. 2010-171148, filed on Jul. 29, 2010; and Japanese Patent Application No. 2010-182558, filed on Aug. 17, 2010, the entire contents of which are incorporated herein by reference.

### BACKGROUND OF THE INVENTION

1. Field of the Invention

The present invention relates to a display apparatus that displays a three-dimensional image by using two pieces of image data.

2. Description of the Related Art

Recently, there are known display apparatuses that acquire a plurality of pieces of image data by capturing images of the same object by a digital stereo camera and display a three-dimensional image (hereinafter, described as a “3D image”), which is viewed as a stereoscopic image by a user, by using the parallax of the object contained in the acquired pieces of image data.

For such display apparatuses, there is a known technology that allows a user to comfortably view a 3D image with polarized glasses (see, for example, Japanese Laid-open Patent Publication No. 2008-123504). In this technology, a transformation curve is obtained by detecting intensity of gray levels of the left and right eyes of a user when the user views a 3D image with polarized glasses; the obtained transformation curve is adjusted to match a previously-obtained leakage value of the polarized glasses before data of the 3D image is output to a display panel; and the 3D image that is comfortable for the user to view is displayed on the display panel.

### SUMMARY OF THE INVENTION

A display apparatus according to an aspect of the present invention includes a display unit that displays a three-dimensional image that is generated by combining two pieces of image data; an area selecting-setting unit that selects an adjustment area whose offset distance is adjusted, the offset distance being a virtual distance from a display screen of the display unit in a direction perpendicular to the display screen in the three-dimensional image displayed by the display unit; an input unit that receives input of a change instruction signal for giving an instruction to change the offset distance of the adjustment area selected by the area selecting-setting unit; an offset-distance adjustment unit that adjusts the offset distance of the adjustment area in accordance with the change instruction signal received by the input unit; and a display controller that causes the display unit to display a three-dimensional image by using the two pieces of image data, in each of which the offset distance of the adjustment area is adjusted by the offset-distance adjustment unit.

A display apparatus according to another aspect of the present invention includes a display unit that displays a composite image that is obtained by superimposing two pieces of image data, in which right-side and left-side portions of respective fields of view overlap each other; a touch panel that is arranged on a display screen of the display unit and that is used for receiving input of a signal corresponding to a contact position of an external object on the touch panel; a parallax adjustment unit that adjusts a parallax of an object contained in the composite image displayed by the display unit, in accordance with a contact trajectory of the object on the touch panel; and a display controller that causes the display unit to display the composite image adjusted by the parallax adjustment unit.

A display apparatus according to still another aspect of the present invention includes a display unit that displays a three-dimensional image that is generated by combining two pieces of image data, in which right-side and left-side portions of respective fields of view overlap each other; a touch panel that is arranged on a display screen of the display unit, detects an area in which an external object approaches the display screen and a distance between the object and the display screen, and receives input of a signal corresponding to a detection result; a protrusion setting unit that sets a protrusion distance, by which the three-dimensional image displayed by the display unit virtually protrudes in a direction perpendicular to the display screen, in accordance with a signal that the touch panel receives in a predetermined area by; and a display controller that causes the display unit to display the three-dimensional image set by the protrusion setting unit.

A display method according to still another aspect of the present invention is performed by a display apparatus that includes a display unit for displaying a composite image that is obtained by superimposing two pieces of image data, in which right-side and left-side portions of respective fields of view overlap each other. The display method includes receiving input of a signal corresponding to a contact position of an external object; adjusting a parallax of an object contained in the composite image displayed by the display unit, in accordance with a contact trajectory of the object; and causing the display unit to display the composite image in which the parallax of the subject is adjusted.

A display method according to still another aspect of the present invention is performed by a display apparatus that displays a three-dimensional image generated by combining two pieces of image data, in which right-side and left-side portions of respective fields of view overlap each other. The display method includes detecting an area, in which an external object approaches a display screen of the display apparatus, and a distance between the object and the display screen; receiving input of a signal corresponding to a detection result; setting a protrusion distance, by which the three-dimensional image virtually protrudes in a direction perpendicular to the display screen, in accordance with the signal; and causing the display unit to display the three-dimensional image in which the protrusion distance is set.

A non-transitory computer-readable storage medium according to still another aspect of the present invention has an executable program stored thereon. The program instructs a processor included in a display apparatus that includes a display unit for displaying a three-dimensional image generated by combining two pieces of image data, in which right-side and left-side portions of respective fields of view overlap each other, to perform: selecting an adjustment area whose offset distance is adjusted, the offset distance being a virtual distance from a display screen of the display unit in a direction perpendicular to the display screen in the three-dimensional image displayed by the display unit; receiving input of a change instruction signal for giving an instruction to change the offset distance of the adjustment area; adjusting the offset distance of the adjustment area in accordance with the change instruction signal; and causing the display unit to display a three-dimensional image by using the two pieces of image data in which the offset distance of the adjustment area is adjusted.

A non-transitory computer-readable storage medium according to still another aspect of the present invention has an executable program stored thereon. The program instructs a processor included in a display apparatus that includes a display unit for displaying a composite image that is obtained by superimposing two pieces of image data, in which right-side and left-side portions of respective fields of view overlap each other, to perform: receiving input of a signal corresponding to a contact position of an external object; adjusting a parallax of an object contained in the composite image displayed by the display unit, in accordance with a contact trajectory of the object; and causing the display unit to display the composite image in which the parallax of the subject is adjusted.

A non-transitory computer-readable storage medium according to still another aspect of the present invention has an executable program stored thereon. The program instructs a processor included in a display apparatus that displays a three-dimensional image generated by combining two pieces of image data, in which right-side and left-side portions of respective fields of view overlap each other, to perform: detecting an area, in which an external object approaches a display screen of the display apparatus, and a distance between the object and the display screen; receiving input of a signal corresponding to a detection result; setting a protrusion distance, by which the three-dimensional image virtually protrudes in a direction perpendicular to the display screen, in accordance with the signal; and causing the display unit to display the three-dimensional image in which the protrusion distance is set.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of a display apparatus according to a first embodiment of the present invention;

FIG. 2 is a schematic diagram of a configuration of a display unit included in the display apparatus according to the first embodiment of the present invention;

FIG. 3 is a schematic diagram illustrating a situation in which an imaging unit of the display apparatus according to the first embodiment of the present invention generates two pieces of image data, in which right-side and left-side portions of respective fields of view overlap each other;

FIG. 4 is a schematic diagram of an example of images corresponding to the two pieces of image data, which are generated by the imaging unit with respect to objects in the situation of FIG. 3 and in which right-side and left-side portions of the respective fields of view overlap each other;

FIG. 5 is a diagram of an example of an image in which a right-eye image and a left-eye image that are generated by the imaging unit in the situation of FIG. 3 are virtually superimposed;

FIG. 6 is a diagram illustrating a relationship between a distance from the imaging unit to each object in the situation of FIG. 3 and the position of each object in the image;

FIG. 7 is a schematic diagram explaining how an adjustment area is selected by an area selecting unit included in the display apparatus according to the first embodiment of the present invention;

FIG. 8 is a schematic diagram illustrating an overview of a process performed by an offset-distance adjustment unit included in the display apparatus according to the first embodiment of the present invention;

FIG. 9 is a flowchart of an overview of a process performed by the display apparatus according to the first embodiment of the present invention;

FIG. 10 is a schematic diagram explaining a user operation of icons arranged in a virtual 3D image that is displayed by the display unit for viewing by a user;

FIG. 11 is a schematic diagram explaining an adjustment method for increasing the parallax of the object, which is performed by the offset-distance adjustment unit;

FIG. 12 is a diagram of an example of composite images generated by a composite-image generating unit;

FIG. 13 is a diagram of an example of a virtual 3D image that is adjusted by the offset-distance adjustment unit for viewing by a user;

FIG. 14 is a schematic diagram explaining an adjustment method for reducing the parallax of the object, which is performed by the offset-distance adjustment unit;

FIG. 15 is a diagram of an example of composite images generated by the composite-image generating unit;

FIG. 16 is a diagram of an example of a virtual 3D image that is adjusted by the offset-distance adjustment unit for viewing by a user;

FIG. 17 is a diagram explaining an overview of protrusion distances of a 3D image that is virtually viewed by a user before and after the offset-distance adjustment unit reduces the parallax of the object;

FIG. 18 is a flowchart of an overview of a playback display process in FIG. 9;

FIG. 19 is a schematic diagram explaining an adjustment method for increasing the parallax of an object, which is performed by an offset-distance adjustment unit according to a modification of the first embodiment of the present invention;

FIG. 20 is a diagram of an example of composite images generated by a composite-image generating unit according to the modification of the first embodiment of the present invention;

FIG. 21 is a diagram of an example a virtual 3D image that is adjusted, for viewing by a user, by the offset-distance adjustment unit according to the modification of the first embodiment of the present invention;

FIG. 22 is a schematic diagram explaining an adjustment method for reducing the parallax of an object, which is performed by the offset-distance adjustment unit according to the modification of the first embodiment of the present invention;

FIG. 23 is a diagram of an example of composite images generated by the composite-image generating unit according to the modification of the first embodiment of the present invention;

FIG. 24 is a diagram of an example of a virtual 3D image that is adjusted, for viewing by a user, by the offset-distance adjustment unit according to the modification of the first embodiment of the present invention;

FIG. 25 is a diagram illustrating a user adjusting the parallax of an object in a 3D image according to the modification of the first embodiment of the present invention;

FIG. 26 is a schematic diagram illustrating a situation in which an imaging unit generates two pieces of image data, in which right-side and left-side portions of respective fields of view overlap each other according to the modification of the first embodiment of the present invention;

FIG. 27 is a block diagram of a configuration of a display apparatus according to a second embodiment of the present invention;

FIG. 28 is a flowchart of an overview of a process performed by the display apparatus according to the second embodiment of the present invention;

FIG. 29 is a flowchart of an overview of a parallax adjustment process in FIG. 28;

FIG. 30 is a diagram explaining a user operation for increasing the parallax of an object contained in a composite image;

FIG. 31 is a diagram of an example of an image displayed by a display unit included in the display apparatus of the second embodiment of the present invention;

FIG. 32 is a diagram of an example of an image displayed by the display unit included in the display apparatus of the second embodiment of the present invention;

FIG. 33 is a diagram explaining a user operation for reducing the parallax of an object contained in a composite image;

FIG. 34 is a flowchart of an overview of a playback display process in FIG. 28;

FIG. 35 is a diagram of an example of a classification image displayed by the display unit included in the display apparatus of the second embodiment of the present invention;

FIG. 36 is a diagram explaining how a parallax adjustment unit according to a modification of the second embodiment of the present invention adjusts the parallax of an object in accordance with two trajectories of external objects on a touch panel;

FIG. 37 is a block diagram of a configuration of a display apparatus according to a third embodiment of the present invention;

FIG. 38 is a schematic diagram of a configuration of a touch panel;

FIG. 39 is a flowchart of an overview of a process performed by the display apparatus according to the third embodiment of the present invention;

FIG. 40 is a schematic diagram explaining operations of icons arranged in a virtual 3D image that is displayed by the display unit for viewing by a user;

FIG. 41 is a schematic diagram explaining a detection area to be detected by a touch panel included in the display apparatus according to the third embodiment of the present invention;

FIG. 42 is a schematic diagram illustrating an overview of a process performed by a protrusion setting unit included in the display apparatus according to the third embodiment of the present invention;

FIG. 43 is a diagram of an example of an image in which a right-eye image and a left-eye image, which are obtained after the protrusion setting unit sets areas to be trimmed by a stereoscopic-image generating unit, are virtually overlapped;

FIG. 44 is a diagram of an example of virtual 3D images that are set by the protrusion setting unit for viewing by a user;

FIG. 45 is a diagram of an example of a virtual 3D image that is adjusted by an exposure adjustment unit for viewing by a user; and

FIG. 46 is a flowchart of an overview of a playback display process in FIG. 39.

### DETAILED DESCRIPTION OF THE PREFERRED EMBODIMENTS

### First Embodiment

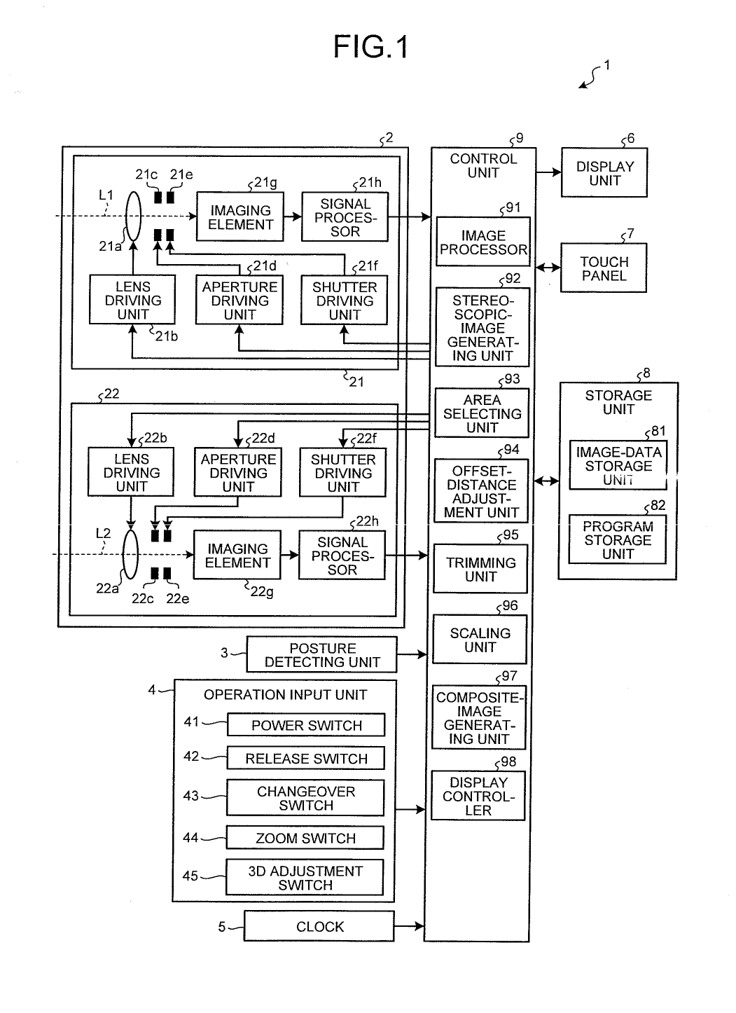

FIG. 1 is a block diagram of a configuration of a display apparatus according to a first embodiment of the present invention. In the embodiment, a digital stereo camera equipped with a display apparatus will be explained as an example. As illustrated in FIG. 1, a display apparatus 1 includes an imaging unit 2 that captures images at different positions and generates two pieces of image data, in which right-side and left-side portions of respective fields of view overlap each other; a posture detecting unit 3 that detects the posture of the display apparatus 1; an operation input unit 4 that receives input of various types of information on the display apparatus 1; a clock 5 that has a shooting date/time determination function and a timer function; a display unit 6 that displays a two-dimensional image (hereinafter, described as a “2D image”) or a 3D image; a touch panel 7 that receives input of signals corresponding to contact positions or contact trajectories of external objects; a storage unit 8 for storing various types of information including image data generated by the imaging unit 2; and a control unit 9 that controls operations of the display apparatus 1.

The imaging unit 2 includes a first imaging unit 21 and a second imaging unit 22. The first imaging unit 21 and the second imaging unit 22 are arranged side by side on the same plane such that optical axes L1 and L2 are parallel or at a predetermined angle to each other.

The first imaging unit 21 includes a lens unit 21a, a lens driving unit 21b, an aperture 21c, an aperture driving unit 21d, a shutter 21e, a shutter driving unit 21f, an imaging element 21g, and a signal processor 21h.

The lens unit 21a includes a focus lens, a zoom lens, or the like and focuses light from a predetermined area of field of view. The lens driving unit 21b includes a DC motor or the like and moves the focus lens, the zoom lens, or the like of the lens unit 21a along the optical axis L1 to change the point of focus or the focal length of the lens unit 21a.

The aperture 21c adjusts exposure by limiting the amount of incident light that is focused by the lens unit 21a. The aperture driving unit 21d includes a stepping motor or the like and drives the aperture 21c.

The shutter 21e sets the state of the imaging element 21g to an exposing state or a light-blocking state. The shutter driving unit 21f includes a stepping motor or the like and drives the shutter 21e in response to a release signal.

The imaging element 21g includes a charge coupled device (CCD) or a complementary metal oxide semiconductor (CMOS), each of which receives light focused by the lens unit 21a and converts the light into electrical signals (analog signals). The imaging element 21g outputs the converted electrical signals to the signal processor 21h.

The signal processor 21h performs signal processing, such as amplification, on the electrical signals output from the imaging element 21g, performs analog-to-digital (A/D) conversion to convert the processed signals to digital image data, and outputs the digital image data to the control unit 9.

The second imaging unit 22 has the same configuration as that of the first imaging unit 21. The second imaging unit 22 includes a lens unit 22a, a lens driving unit 22b, an aperture 22c, an aperture driving unit 22d, a shutter 22e, a shutter driving unit 22f, an imaging element 22g, and a signal processor 22h.

The posture detecting unit 3 includes an accelerometer and detects the posture of the display apparatus 1 by detecting the acceleration of the display apparatus 1. Specifically, the posture detecting unit 3 detects the posture of the display apparatus 1 with reference to a horizontal plane.

The operation input unit 4 includes a power switch 41 for switching on or off the power supply to the display apparatus 1; a release switch 42 for inputting a release signal to give an instruction to capture a still image; a changeover switch 43 for switching between various shooting modes or between various settings of the display apparatus 1; a zoom switch 44 for performing a zoom operation of the imaging unit 2; and a 3D adjustment switch 45 for displaying, on the display unit 6, an icon for adjusting a 3D image.

The clock 5 generates a time signal used as a reference for operations of the display apparatus 1. With the time signal, the control unit 9 can set an image-data acquisition time, exposure times of the imaging elements 21g and 22g, or the like.

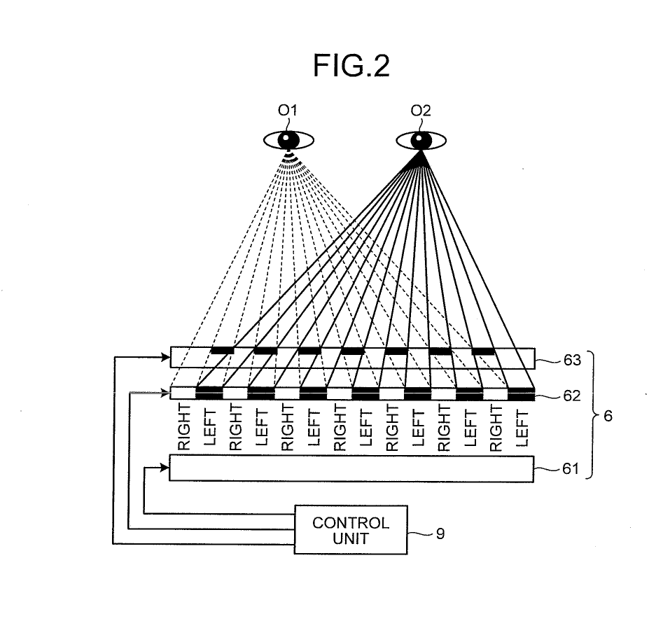

FIG. 2 is a schematic diagram of a configuration of the display unit 6. As illustrated in FIG. 2, the display unit 6 includes a backlight 61, a display panel 62, and a parallax barrier 63. The backlight 61 includes a light emitting diode (LED) or the like and emits light from a backside of an image to be displayed. The display panel 62 includes a display panel made of liquid crystals, organic electroluminescence (EL) materials, or the like. The parallax barrier 63 is made of liquid crystals or the like and disposed on the top surface of the display panel 62. The parallax barrier 63 has slits at intervals narrower than intervals between pixels of the display panel 62 and separates images corresponding to a right eye O1 and a left eye O2 of a user. The parallax barrier 63 of the embodiment separates images corresponding to the right eye O1 and the left eye O2. In the embodiment, a parallax barrier system is applied to the parallax barrier 63.

In the display unit 6 configured as above, when 3D image data is input from the control unit 9, the display panel 62 alternately displays a right-eye image and a left-eye image in sequence starting from the leftmost pixel in the horizontal direction and the parallax barrier 63 separates the light emitted from each pixel of the display panel 62, under the control of the control unit 9. Consequently, the right-eye image only reaches the right eye O1 and the left-eye image only reaches the left eye O2. Therefore, the user can view the 3D image displayed on the display unit 6 as a stereoscopic image. When the display unit 6 changes the display mode from a 3D image to a 2D image, a voltage applied to the parallax barrier 63 is switched from the ON state to the OFF state, so that the parallax barrier 63 is switched from a light-blocking state to a transmissive state. Accordingly, either one of the right-eye image and the left-eye image is output to the display panel 62, so that a 2D image is displayed.

The touch panel 7 is overlaid on a display screen of the display unit 6. The touch panel 7 detects an area or a trajectory contacted (touched) by a user in accordance with information or an image displayed on the display unit 6, and receives input of an operation signal corresponding to the touch area or the touch trajectory. In general, resistive touch panels, capacitive touch panels, and optical touch panels are known. In the embodiment, any of the above touch panels can be used. In the embodiment, the touch panel 7 also functions as an input unit.

The storage unit 8 includes an image-data storage unit 81 for storing image data of images captured by the imaging unit 2; and a program storage unit 82 for storing various programs to be executed by the display apparatus 1. The storage unit 8 is realized by a semiconductor memory, such as a flash memory or a random access memory (RAM), which is fixedly provided inside the display apparatus 1. The storage unit 8 may have a function of a recording-medium interface that stores information in an external recording medium, such as a memory card, attached thereto and that reads out information stored in the recording medium.

The control unit 9 is realized by a central processing unit (CPU) or the like. The control unit 9 reads and executes programs stored in the program storage unit 82 of the storage unit 8 in accordance with an operation signal or the like received from the operation input unit 4 and sends instructions or data to each unit of the display apparatus 1 to thereby control the overall operation of the display apparatus 1. The control unit 9 includes an image processor 91, a stereoscopic-image generating unit 92, an area selecting unit 93, an offset-distance adjustment unit 94, a trimming unit 95, a scaling unit 96, a composite-image generating unit 97, and a display controller 98.

The image processor 91 performs various types of image processing on the left-eye image data and the right-eye image data that are respectively output from the signal processors 21h and 22h, and outputs the processed image data to the image-data storage unit 81 of the storage unit 8. Specifically, the image processor 91 performs processing, such as edge enhancement, color correction, and γ correction, on left-eye image data and right-eye image data that are respectively output from the signal processors 21h and 22h.

The stereoscopic-image generating unit 92 generates a 3D image by trimming each of the right-eye image data and the left-eye image data, on which the image processor 91 has performed image processing, at a predetermined vertical-to-horizontal ratio, e.g., at an aspect ratio of 3:4. The vertical-to-horizontal ratio at which the left-eye image data and the right-eye image data are trimmed by the stereoscopic-image generating unit 92 may be set via the changeover switch 43.

The area selecting unit 93 selects an adjustment area, in which a virtual offset distance in a direction perpendicular to the display screen of the display unit 6 is to be adjusted in the 3D image displayed by the display unit 6. Specifically, the area selecting unit 93 selects, as the adjustment area, an area in which an object specified by an input signal received by the touch panel 7 is displayed in the 3D image displayed by the display unit 6, by using the known principle of triangulation.

The offset-distance adjustment unit 94 adjusts the offset distance of the adjustment area, which is contained in each of the right-eye image data and the left-eye image data subjected to the image processing by the image processor 91 and which is selected by the area selecting unit 93, in accordance with a change instruction signal that is received by the touch panel 7 and that is used for changing the offset distance of the adjustment area. Specifically, the offset-distance adjustment unit 94 adjusts the parallax of the object, which is specified by the input signal received by the touch panel 7, in accordance with the change instruction signal that is received by the touch panel 7 and that is used for giving an instruction to change the offset distance.

The trimming unit 95 generates a trimming image by trimming the adjustment area selected by the area selecting unit 93. Specifically, the trimming unit 95 trims an area in which the object specified by the input signal received by the touch panel 7 is displayed from each of the right-eye image and the left-eye image of the 3D image displayed by the display unit 6 to thereby generate the trimming image. In the specification, trimming means generation of an image that is trimmed along with a contour of an object contained in an image. The trimming image means an image that is generated by trimming an object from an image along with the contour of the object.

The scaling unit 96 generates an enlarged trimming image or a reduced trimming image by enlarging or reducing the trimming image generated by the trimming unit 95. Specifically, the scaling unit 96 generates enlarged trimming images or reduced trimming images by enlarging or reducing the righty-eye trimming image and the left-eye trimming image that are respectively trimmed from the right-eye image and the left-eye image by the trimming unit 95. More specifically, the scaling unit 96 generates the enlarged trimming images or the reduced trimming images by enlarging or reducing the trimming images with a predetermined scaling factor based on the parallax and the offset distance of the object adjusted by the offset-distance adjustment unit 94.

The composite-image generating unit 97 generates composite images by superimposing the enlarged trimming images or the reduced trimming images generated by the scaling unit 96 onto object areas. Specifically, the composite-image generating unit 97 generates, in the 3D image displayed on the display unit 6, a right-eye composite image and a left-eye composite image by superimposing the enlarged trimming images or the reduced trimming images generated by the scaling unit 96 onto respective areas that are contained in the righty-eye image and the left-eye image and that correspond to the object specified by the input signal received by the touch panel 7.

The display controller 98 causes the display unit 6 to display a 3D image or a 2D image. Specifically, when causing the display unit 6 to display a 3D image, the display controller 98 outputs, to the display unit 6, a 3D image in which the right-eye image and the left-eye image of the 3D image generated by the stereoscopic-image generating unit 92 are alternately aligned one pixel by one pixel in the horizontal direction of the display screen of the display unit 6. When causing the display unit 6 to display a 2D image, the display controller 98 changes the power supply to the parallax barrier 63 from the ON state to the OFF state in order to switch the parallax barrier 63 of the display unit 6 from the light-blocking state to the transmissive state and outputs only one of the left-eye image and the right-eye image to the display panel 62. The display controller 98 also causes the display unit 6 to display a 3D image by using the right-eye image data and the left-eye image data, for each of which the parallax of the object in the 3D image has been adjusted by the offset-distance adjustment unit 94. The display controller 98 also causes the display unit 6 to display a 3D image by using the right-eye image data and the left-eye image data, on each of which the enlarged trimming image or the reduced trimming image generated by the scaling unit 96 is superimposed by the composite-image generating unit 97.

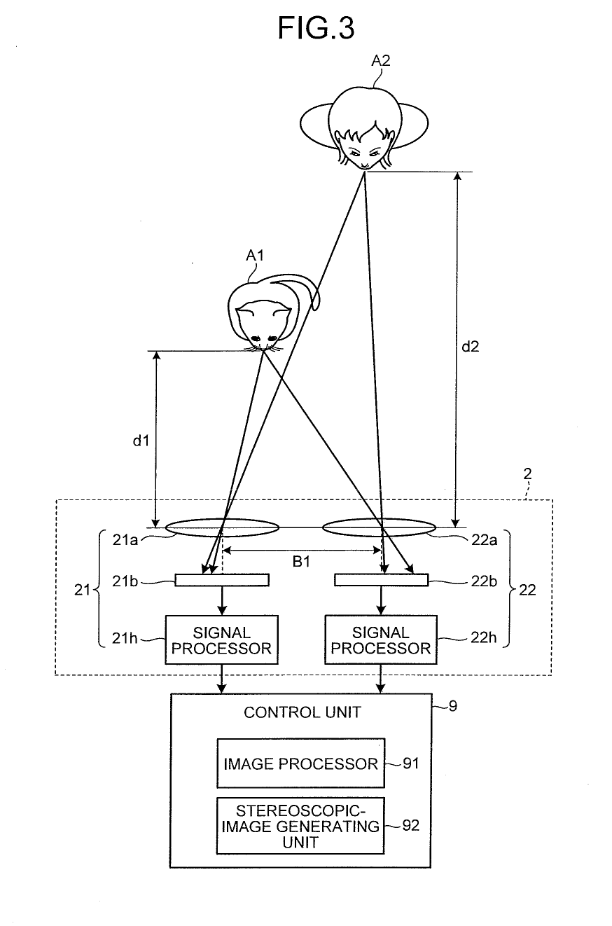

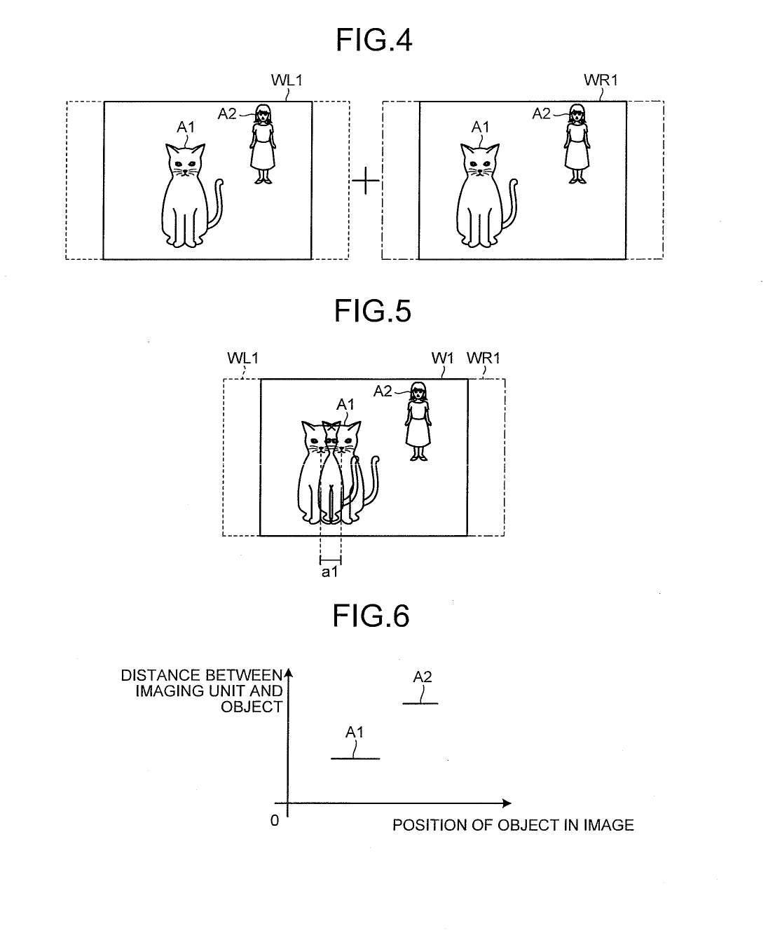

Regarding the display apparatus 1 having the above configuration, a situation will be explained in which the imaging unit 2 generates two pieces of image data, in which right-side and left-side portions of respective fields of view overlap each other. FIG. 3 is a schematic diagram illustrating a situation in which the imaging unit 2 generates two pieces of image data, in which right-side and left-side portions of respective fields of view overlap each other. FIG. 4 is a schematic diagram of an example of two images corresponding to the two pieces of image data generated by the imaging unit 2 in the situation of FIG. 3. In FIG. 4, an image WR1 is a right-eye image that the stereoscopic-image generating unit 92 has generated by trimming the image corresponding to the right-eye image data generated by the first imaging unit 21, and an image WL1 is a left-eye image that the stereoscopic-image generating unit 92 has generated by trimming the image corresponding to the left-eye image data generated by the second imaging unit 22. FIG. 5 is a diagram of an example of an image, in which the right-eye image and the left-eye image that are generated by the stereoscopic-image generating unit 92 in the situation in FIG. 3 are virtually superimposed. FIG. 6 is a diagram illustrating a relationship between a distance from the imaging unit 2 to each object in the situation of FIG. 3 and the position of each object in the image. In FIG. 6, the horizontal axis represents the position of the object in an image W1 where the left edge is used as the origin and the vertical axis represents the distance between the imaging unit 2 and the object. In FIGS. 4 and 5, dashed lines and chain lines represent image areas corresponding to respective pieces of image data generated by the first imaging unit 21 and the second imaging unit 22.

As illustrated in FIG. 3, the imaging unit 2 generates right-eye image data and left-eye image data by causing each of the first imaging unit 21 and the second imaging unit 22, which are arranged side by side at a distance (base length) B1 therebetween, to capture images of an object A1 (a distance d1) and an object A2 (a distance d2) that are located at different distances from the imaging unit 2. Thereafter, the stereoscopic-image generating unit 92 trims the right-eye image data and the left-eye image data, on each of which the image processing has been performed by the image processor 91, at a predetermined vertical-to-horizontal ratio to generate the right-eye image WR1 and the left-eye image WL1 (see FIG. 4). As illustrated in FIG. 6, the distance between the imaging unit 2 and the object A2 is longer than the distance between the imaging unit 2 and the object A1. Therefore, the areas of the object A2 nearly overlap each other. Specifically, as illustrated in FIG. 5, the areas of the object A2 nearly overlap each other in the image w1.

On the other hand, the areas of the object A1 do not overlap each other and there is a parallax al of the object A1. As described above, in the right-eye image WR1 and the left-eye image WL1, the parallax of the object (the object A1) located at a close distance from the imaging unit 2 is large in the 3D image and the parallax of the object (the object A2) located at a far distance from the imaging unit 2 is small in the 3D image.

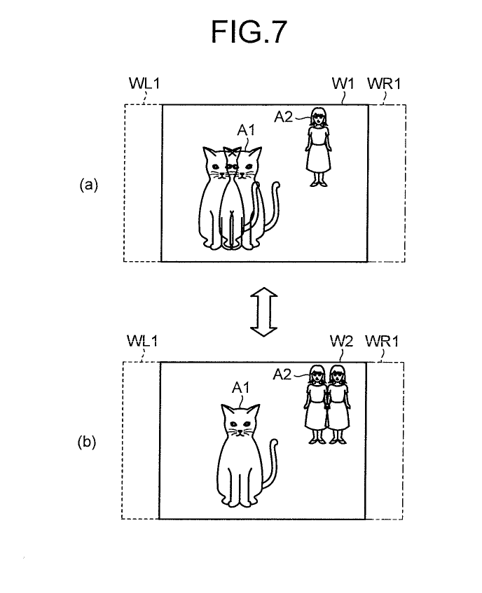

The adjustment area selected by the area selecting unit 93 will be explained below. FIG. 7 is a schematic diagram explaining how the adjustment area is selected by the area selecting unit 93. As illustrated in FIG. 7, the area selecting unit 93 selects, as the adjustment area, an object area of an object that is contained in the 3D image displayed by the display unit 6 and that is specified by an input signal received by the touch panel 7. Specifically, as illustrated in (a) of FIG. 7, when a user touches a part of the object A2 in the 3D image displayed by the display unit 6, the area selecting unit 93 identifies a non-overlapping area in the image w1, in which the objects A2 do not overlap each other, as a background image and identifies an overlapping area in the image w1, in which the objects A2 overlap each other, as the object area of the object A2 contained in the 3D image. Therefore, when the user touches a part of the object A2 in the 3D image displayed by the display unit 6, the area selecting unit 93 can select the object area of the object A2 as the adjustment area.

Similarly, as illustrated in (b) of FIG. 7, when the user touches a part of the object A1 in the 3D image displayed by the display unit 6, the area selecting unit 93 superimposes the object A1 in the right-eye image WR1 and the object A1 in the left-eye image WL1, and thereafter identifies a non-overlapping area in an image W2, in which the objects A1 do not overlap each other, as a background image and identifies an overlapping area in the image W2, in which the objects A1 overlap each other, as the object area of the object A1 contained in the 3D image. Therefore, when the user touches a part of the object A1 in the 3D image displayed by the display unit 6, the area selecting unit 93 can select the object area of the object A1 as the adjustment area.

As described above, when the user touches a part of the object in the 3D image displayed by the display unit 6, the area selecting unit 93 identifies the object area of the object contained in the 3D image on the basis of the right-eye image and the left-eye image that are generated by the stereoscopic-image generating unit 92 and selects the identified object area as the adjustment area. When superimposing the objects contained in the right-eye image and the left-eye image generated by the stereoscopic-image generating unit 92, the area selecting unit 93 may identify the object area of the object contained in the 3D image by detecting face areas of the objects by pattern matching or the like and overlapping the areas of the objects with reference to the detected face areas. In addition, the area selecting unit 93 may identify the object area of the object contained in the 3D image by superimposing areas of the objects with reference to a position at which a contrast value or a focus value is the greatest.

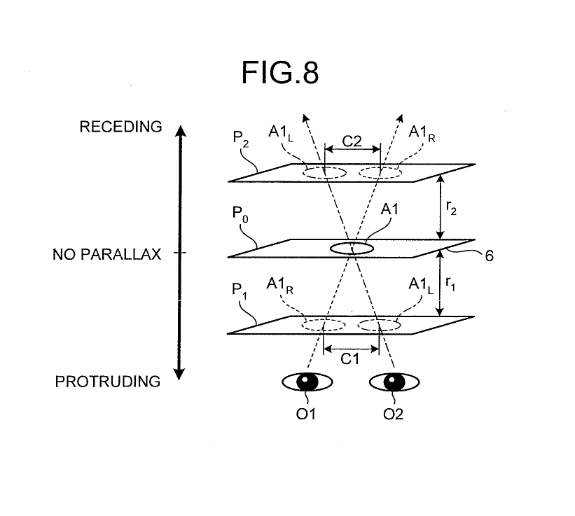

An overview of a process performed by the offset-distance adjustment unit 94 will be explained. FIG. 8 is a schematic diagram illustrating the overview of the process performed by the offset-distance adjustment unit 94. P₀ in FIG. 8 represents a position at which an object contained in a 3D image is displayed without a parallax (a 2D image). P₁ in FIG. 8 represents a protruding position at which the object contained in the 3D image virtually protrudes from the initial position in a direction perpendicular to the display screen of the display unit 6. P₂ in FIG. 8 represents a receding position at which the object contained in the 3D image virtually recedes from the initial position in the direction perpendicular to the display screen of the display unit 6. In FIG. 8, the object A1 illustrated in FIGS. 3 to 6 will be explained as an example.

As illustrated in FIG. 8, when causing the object A1, which is specified by the input signal received by the touch panel 7, to virtually protrude in the direction perpendicular to the display screen of the display unit 6 in the 3D image displayed by the display unit 6 (the position P₀→the position P₁), the offset-distance adjustment unit 94 adjusts the parallax between an object image A1_{R} of the object A1 contained in the right-eye image and an object image A1_{L}, of the object A1 contained in the left-eye image. Consequently, the offset-distance adjustment unit 94 can adjust a distance r₁ (hereinafter, described as a “protrusion distance”) by which the object A1 virtually protrudes in the direction perpendicular to the display screen of the display unit 6. Specifically, when causing the protruding object A1 to virtually protrude farther in the direction perpendicular to the display screen of the display unit 6, the offset-distance adjustment unit 94 increases a parallax C1 between the object image A1_{R} and the object image A1_{L}, so that the protrusion distance r₁ of the object A1 can be increased. On the other hand, when causing the protruding object A1 to virtually recede in the direction perpendicular to the display screen of the display unit 6, the offset-distance adjustment unit 94 reduces the parallax C1 between the object image A1_{R} and the object image A1_{L}, so that the protrusion distance r₁ of the object A1 can be reduced.

When causing the object A1, which is specified by the input signal received by the touch panel 7, to virtually recede in the direction perpendicular to the display screen of the display unit 6 (the position P₀→the position P₂), the offset-distance adjustment unit 94 adjusts the parallax between the object image A1_{R} of the object A1 contained in the right-eye image and the object image A1_{L}, of the object A1 contained in the left-eye image. Consequently, the offset-distance adjustment unit 94 can adjust a distance r₂ (hereinafter, described as a “receding distance”) by which the object A1 virtually recedes in the direction perpendicular to the display screen of the display unit 6. Specifically, when causing the receding object A1 to virtually recede farther in the direction perpendicular to the display screen of the display unit 6, the offset-distance adjustment unit 94 increases a parallax C2 between the object image A1_{R} and the object image A1_{L}, so that the receding distance r₂ of the object A1 can be increased. On the other hand, when causing the receding object A1 to virtually protrude in the direction perpendicular to the display screen of the display unit 6, the offset-distance adjustment unit 94 reduces the parallax C2 between the object image A1_{R} and the object image A1_{L}, so that the receding distance r₂ of the object A1 can be reduced.

As described above, the offset-distance adjustment unit 94 separately adjusts parallaxes of object images contained in the right-eye image and the left-eye image with respect to the objects that are contained in the 3D image and that are specified via the touch panel 7; and the display controller 98 causes the display unit 6 to display a 3D image by using the right-eye image and the left-eye image, for each of which the parallaxes of the objects have been adjusted by the offset-distance adjustment unit 94. Therefore, a user can adjust an offset distance of a desired object by touching the object in the 3D image displayed by the display unit 6.

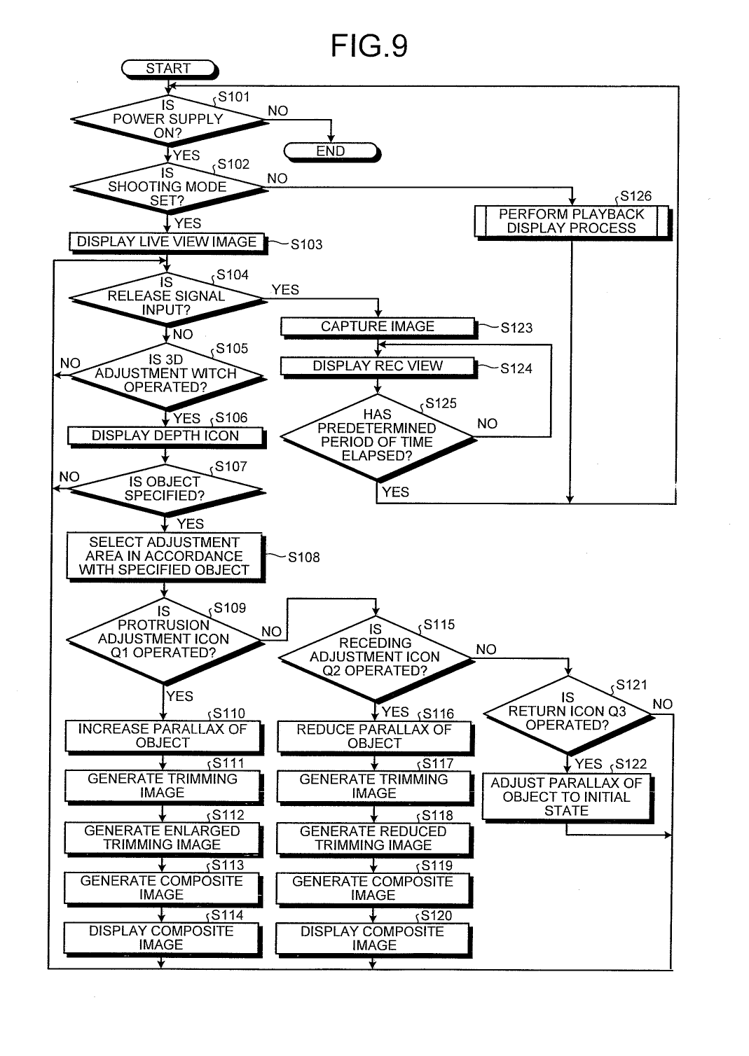

The process performed by the display apparatus 1 according to the embodiment will be explained. FIG. 9 is a flowchart of an overview of the process performed by the display apparatus 1. In the following, a process performed on a 3D image that is virtually protruding in the direction perpendicular to the display screen of the display unit 6 will be explained as an example.

In FIG. 9, the control unit 9 determines whether the power supply to the display apparatus 1 is on (Step S101). When the power supply to the display apparatus 1 is on (YES at Step S101), the display apparatus 1 goes to Step S102. On the other hand, when the power supply to the display apparatus 1 is not on (NO at Step S101), the display apparatus 1 ends the process.

The control unit 9 determines whether the display apparatus 1 is set to a shooting mode (Step S102). When the display apparatus 1 is set to the shooting mode (YES at Step S102), the display apparatus 1 goes to Step S103 to be described below. On the other hand, when the display apparatus 1 is not set to the shooting mode (NO at Step S102), the display apparatus 1 goes to Step S126 to be described below.

A case at Step S102 will be described below where the display apparatus 1 is set to the shooting mode (YES at Step S102). In this case, the display controller 98 causes the display unit 6 to display a live view image of a 3D image corresponding to pieces of image data that the imaging unit 2 has sequentially generated at predetermined small time intervals (Step S103).

The control unit 9 determines whether a user operates the release switch 42 and a release signal for giving an instruction to capture an image is input (Step S104). When the release signal for giving the instruction to capture an image is input (YES at Step S104), the display apparatus 1 goes to Step S123 to be described below. On the other hand, when the release signal for giving the instruction to capture an image is not input (NO at Step S104), the display apparatus 1 goes to Step S105 to be described below.

A case at Step S104 will be explained below where the release signal for giving the instruction to capture an image is not input (NO at Step S104). In this case, the control unit 9 determines whether the user operates the 3D adjustment switch 45 and an instruction signal is input for causing the display unit 6 to display a depth icon that is used for adjusting a protrusion distance of an object in the 3D image (Step S105). When the 3D adjustment switch 45 is not operated (NO at Step S105), the display apparatus 1 returns to Step S104. On the other hand, when the 3D adjustment switch 45 is operated (YES at Step S105), the display apparatus 1 goes to Step S106.

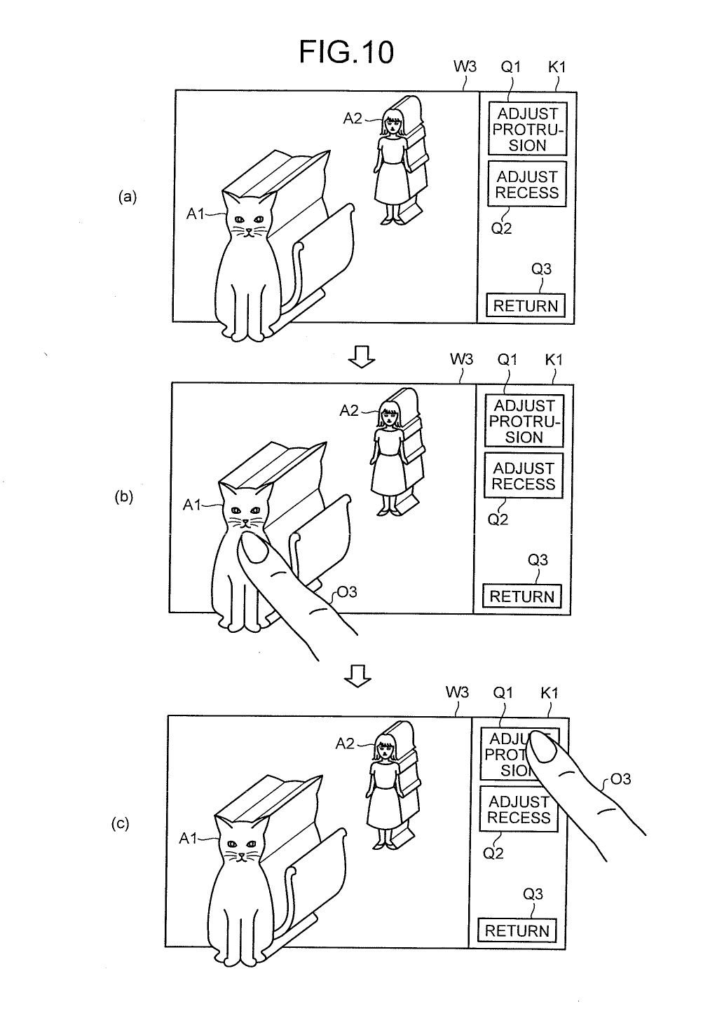

The display controller 98 displays the depth icon, which is used for adjusting a protrusion distance of an object in the 3D image, on the 3D image displayed by the display unit 6 (Step S106). Specifically, as illustrated in (a) of FIG. 10, the display controller 98 displays a protrusion adjustment icon Q1, a receding adjustment icon Q2, and a return icon Q3 in a right edge area K1 of a 3D image W3 displayed by the display unit 6. The right edge area K1 in the 3D image W3 is an area where a user is allowed to check operating information or to operate (touch) icons. It is satisfactory if the operating information, such as icons, can be displayed as 2D images on the right edge area K1. The display controller 98 may display the icons or the like as 3D images on the right edge area K1.

The control unit 9 determines whether the object A1 is specified by an input signal received by the touch panel 7 (Step S107). Specifically, as illustrated in (b) of FIG. 10, the control unit 9 determines whether the user touches the object A1 in the 3D image W3 with a finger O3 so that the object A1 is specified according to an input signal received by the touch panel 7. When the object A1 is not specified by the input signal received by the touch panel 7 (NO at Step S107), the display apparatus 1 returns to Step S104. On the other hand, when the object is specified by the input signal received by the touch panel 7 (YES at Step S107), the display apparatus 1 goes to Step S108 to be described below.

The area selecting unit 93 selects, as the adjustment area, the object specified by the input signal received by the touch panel 7 (Step S108).

The control unit 9 determines whether the protrusion adjustment icon Q1, which is used for causing the object to virtually protrude in the direction perpendicular to the display screen of the display unit 6, is operated (Step S109). Specifically, as illustrated in (c) of FIG. 10, the control unit 9 determines whether the user touches the protrusion adjustment icon Q1 with the finger O3 so that the protrusion adjustment icon Q1 is operated according to the input signal received by the touch panel 7. When the protrusion adjustment icon Q1 is operated (YES at Step S109), the offset-distance adjustment unit 94 adjusts the parallax of the object so that the parallax is increased by a predetermined amount (Step S110).

The trimming unit 95 generates a trimming image by trimming the object selected by the area selecting unit 93 from each of the right-eye image and the left-eye image (Step S111). The scaling unit 96 generates an enlarged trimming image by enlarging the object on the basis of the parallax of the object and the protrusion distance of the object, which are adjusted by the offset-distance adjustment unit 94 (Step S112).

The composite-image generating unit 97 generates a composite image by superimposing the enlarged trimming image generated by the scaling unit 96 onto the area of the object (Step S113). The display controller 98 causes the display unit 6 to display a 3D image by using the composite image generated by the composite-image generating unit 97 (Step S114). Thereafter, the display apparatus 1 returns to Step S104.

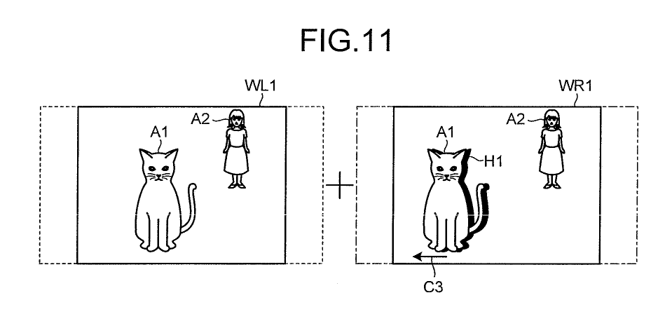

FIG. 11 is a schematic diagram explaining an adjustment method for increasing the parallax of the object A1, which is performed by the offset-distance adjustment unit 94. As illustrated in FIG. 11, the offset-distance adjustment unit 94 adjusts the parallax of the object A1, which is contained in each of the right-eye image WR1 and the left-eye image WL1 generated by the stereoscopic-image generating unit 92, so that the parallax is increased by a predetermined amount. Specifically, as illustrated in FIG. 11, the offset-distance adjustment unit 94 moves the object A1 in the right-eye image WR1 by a predetermined amount, e.g., 1/10 of the parallax, in the leftward direction (along an arrow C3) so that the parallax is increased. Therefore, the user can separately increase the protrusion distance of the touched object A1 in the 3D image displayed by the display unit 6. In the right-eye image WR1, however, a lost area H1 (a black area in FIG. 11), in which pixels are lost, is generated because the offset-distance adjustment unit 94 has moved the object A1 in the right-eye image WR1.

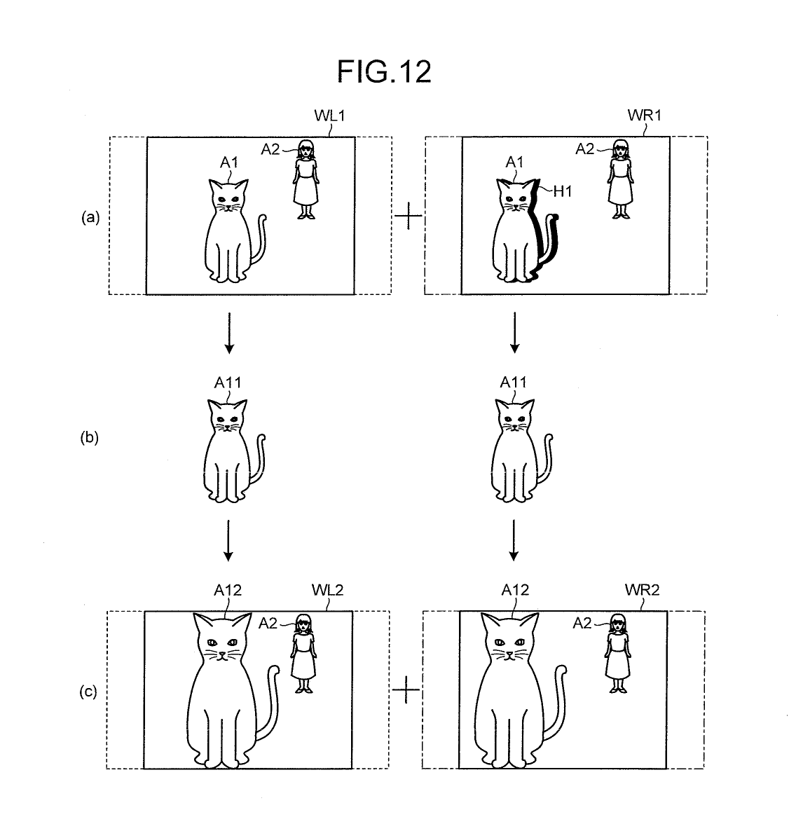

To cope with this, as illustrated in FIG. 12, the trimming unit 95 generates a trimming image A11 by trimming the object A1 from each of the right-eye image WR1 and the left-eye image WL1 (see (b) of FIG. 12). The trimming image means an image that is generated by trimming an object (a cat) from each of the right-eye image and the left-eye image along with a contour of the object.

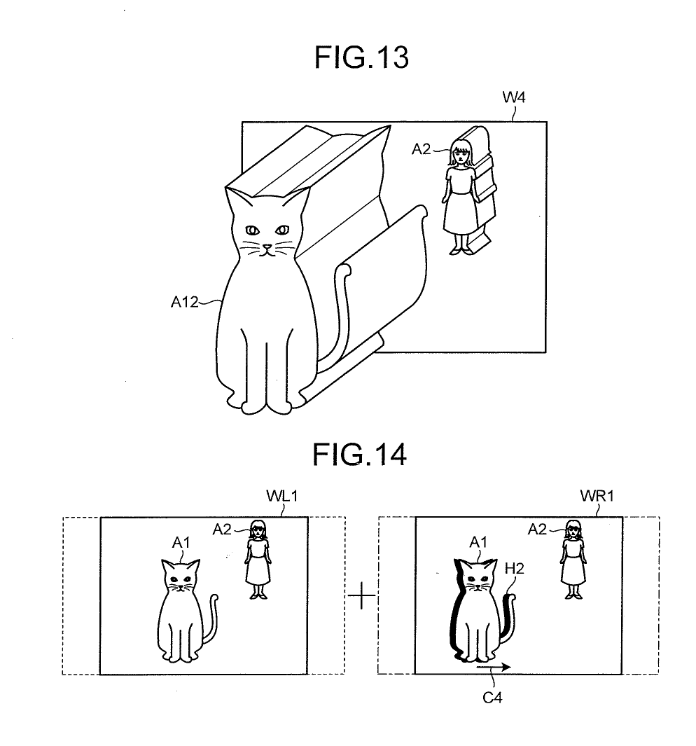

Thereafter, the scaling unit 96 generates an enlarged trimming image A12 by enlarging the trimming image A11 of each of the right-eye image WR1 and the left-eye image WL1 in accordance with the parallax of the object A1 and the protrusion distance, which are adjusted by the offset-distance adjustment unit 94. Then, the composite-image generating unit 97 generates a right-eye composite image WR2 and a left-eye composite image WL2 by superimposing the enlarged trimming image A12 generated by the scaling unit 96 onto the areas of the objects A1 ((c) of FIG. 12). The display controller 98 then causes the display unit 6 to display a 3D image (see an image W4 in FIG. 13) by using the right-eye composite image WR2 and the left-eye composite image WL2.

As described above, the display apparatus 1 can interpolate the pixels in the lost area H1 by enlarging the object A1 so that the object A1 protrudes toward the user. Therefore, the user can adjust the protrusion distance of the touched object in the 3D image displayed by the display unit 6 and can virtually view the smooth 3D image W4. In FIG. 11, only the object A1 in the right-eye image WR1 is moved. However, it is possible to adjust the parallax of the object A1 so that the parallax is increased while synchronizing the object A1 in the left-eye image WL1 and the object A1 in the right-eye image WR1. It is also possible to move only the object A1 in the left-eye image WL1.

Referring back to FIG. 9, a case at Step S109 will be explained below where the protrusion adjustment icon Q1 is not operated (NO at Step S109). In this case, the control unit 9 determines whether the user operates the receding adjustment icon Q2 ((a) of see FIG. 10), which is used for causing the object to virtually recede in the direction perpendicular to the display screen of the display unit 6 (Step S115). When the receding adjustment icon Q2 is operated (YES at Step S115), the display apparatus 1 goes to Step S116 to be described below. On the other hand, when the receding adjustment icon Q2 is not operated (NO at Step S115), the display apparatus 1 goes to Step S121 to be described below.

A case at Step S115 will be explained below where the user operates the receding adjustment icon Q2, which is used for causing the object to virtually recede in the direction perpendicular to the display screen of the display unit 6 (YES at Step S115). In this case, the offset-distance adjustment unit 94 adjusts the parallax of the object so that the parallax is reduced by a predetermined amount (Step S116). Then, the trimming unit 95 generates a trimming image by trimming the object selected by the area selecting unit 93 from each of the right-eye image and the left-eye image (Step S117).

The scaling unit 96 generates a reduced trimming image by reducing the trimming image generated by the trimming unit 95 on the basis of the parallax of the object and the protrusion distance of the object, which are adjusted by the offset-distance adjustment unit 94 (Step S118). The composite-image generating unit 97 generates a composite image by superimposing the reduced trimming image generated by the scaling unit 96 onto the area of the object (Step S119).

Thereafter, the display controller 98 causes the display unit 6 to display a 3D image by using the composite image generated by the composite-image generating unit 97 (Step S120), and the display apparatus 1 returns to Step S104.

FIG. 14 is a schematic diagram explaining an adjustment method performed by the offset-distance adjustment unit 94 for reducing the parallax of the object. As illustrated in FIG. 14, the offset-distance adjustment unit 94 adjusts the parallax of the object A1 contained in each of the right-eye image WR1 and the left-eye image WL1, which are generated by the stereoscopic-image generating unit 92, so that the parallax is reduced by a predetermined amount. Specifically, as illustrated in FIG. 14, the offset-distance adjustment unit 94 moves the object A1 in the right-eye image WR1 by a predetermined amount, e.g., 1/10 of the parallax, in the rightward direction (along an arrow C4) so that the parallax is reduced. Therefore, the user can separately reduce the protrusion distance of the touched object A1 in the 3D image displayed by the display unit 6. However, the user may feel discomfort because a balance of depth is disturbed between the object A1 and the object A2 in the 3D image that the user virtually views. Furthermore, similarly to Step S110 described above, a lost area H2 (a black area in FIG. 14), in which pixels are lost, is generated.

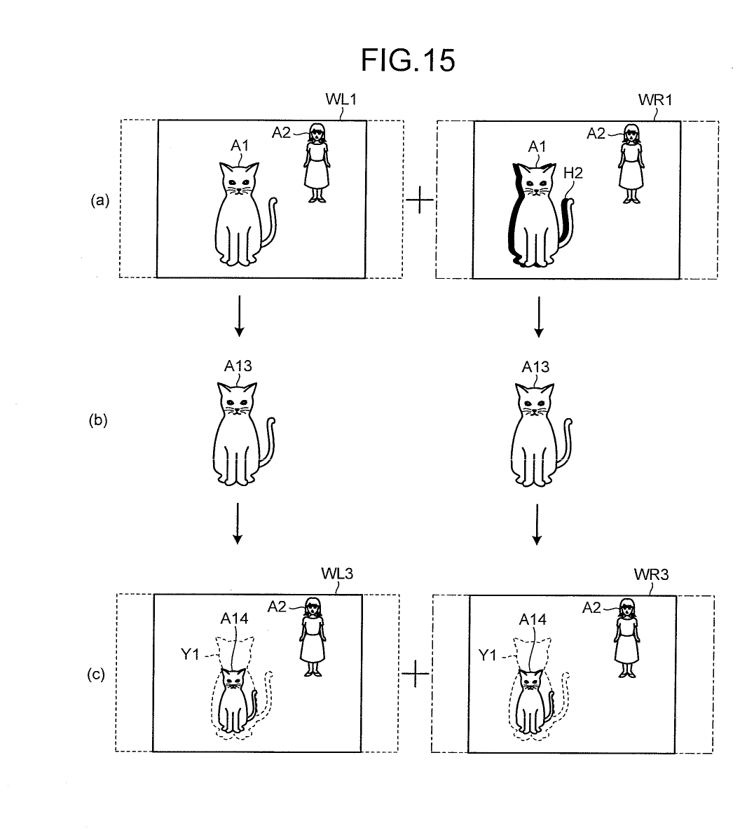

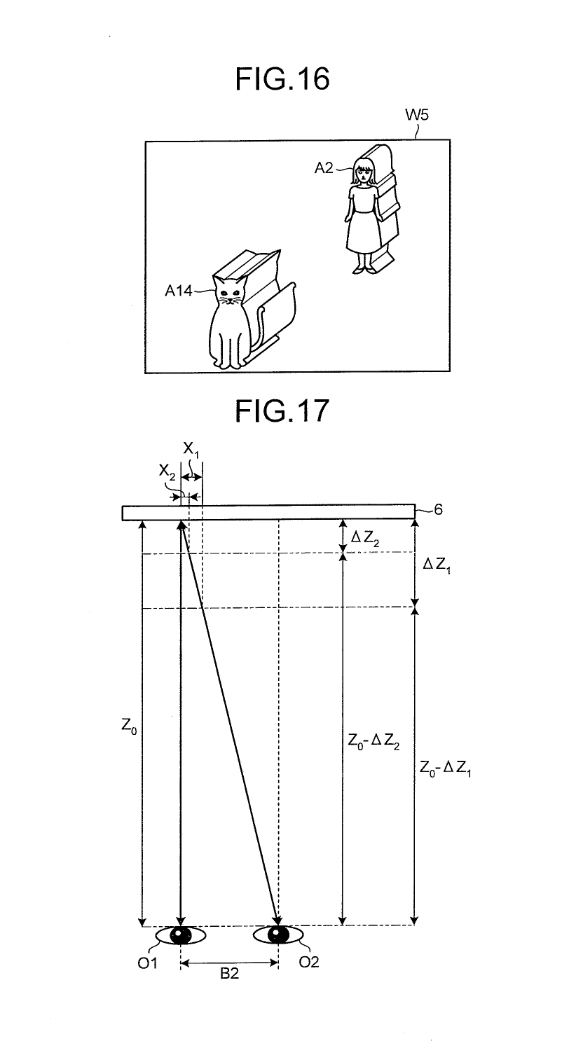

To cope with this, as illustrated in FIG. 15, the trimming unit 95 generates a trimming image A13 by trimming the object A1 from each of the right-eye image WR1 and the left-eye image WL1 (see (b) of FIG. 15). Thereafter, the scaling unit 96 generates a reduced trimming image A14 by reducing the trimming image A13 of each of the right-eye image WR1 and the left-eye image WL1 in accordance with the parallax of the object A1 and the protrusion distance, which are adjusted by the offset-distance adjustment unit 94. Then, the composite-image generating unit 97 generates a right-eye composite image WR3 and a left-eye composite image WL3 by superimposing the reduced trimming image A14 generated by the scaling unit 96 onto the areas of the object A1 and by interpolating an area Y1 (an area surrounded by a dashed line in FIG. 15) by performing a known interpolation process on the pixels in the lost area H2 ((c) of FIG. 15). Subsequently, the display controller 98 causes the display unit 6 to display a 3D image (see an image W5 in FIG. 16) by using the right-eye composite image WR3 and the left-eye composite image WL3. The composite-image generating unit 97 may perform an interpolation process on the lost area H2 so that the area Y1 is interpolated by an image that has a lower brightness than that of the object A1 and/or by a blurred image.

FIG. 17 is a diagram explaining an overview of the protrusion distance of a 3D image that is virtually viewed by a user before and after the offset-distance adjustment unit 94 reduces the parallax of the object. In FIG. 17, B₂ represents an intra-ocular distance, which is set to, for example, 6.5 cm; and Z₀ represents a distance (a visual distance) from the display unit 6 to the eyes O1 and O2 of the user, which is set to, for example 40 cm. When the parallax of the object before the adjustment by the offset-distance adjustment unit 94 is represented by X₁ and a corresponding protrusion distance of the object in the 3D image is represented by ΔZ₁, the following is obtained with reference to FIG. 17.

X₁:ΔZ₁=B₂:Z₀ (1)

Therefore, the following is obtained.

ΔZ₁=(Z₀/B₂)×X₁ (2)

In contrast, when the parallax of the object after the adjustment by the offset-distance adjustment unit 94 is represented by X₂ and a corresponding protrusion distance of the object in the 3D image is represented by ΔZ₂, the following is obtained with reference to FIG. 17.

X₂:ΔZ₂=B₂:Z₀ (3)

Therefore, the following is obtained.

ΔZ₂=(Z₀/B₂)×X₂ (4)

When the offset-distance adjustment unit 94 moves the right-eye image by 1/10 of the parallax X₁ before the adjustment, the parallax X₂ after the adjustment becomes such that X₂=(X₁−X₁/10). Therefore, according to Equation (4), the offset-distance adjustment unit 94 obtains the protrusion distance ΔZ₂ of the object as follows.

ΔZ₂=(Z₀/B₂)×(X₁−X₁/10) (5)

Consequently, the user can virtually view the adjusted object at the protrusion distance ΔZ₂.

A reduction ratio V used for reducing the object by the scaling unit 96 is set, for example, as follows.

V=(Z₀−ΔZ₁)/(Z₀−ΔZ₂) (6)

Accordingly, the scaling unit 96 can generate a reduced trimming image by reducing the object while maintaining a balance between the objects in the 3D image. Equation (6) is described by way of example only, and the reduction ratio may be set by multiplying the right side of Equation (6) by a factor k on the basis of the experimental rules as described below.

V′=k×((Z₀−ΔZ₁)/(Z₀−ΔZ₂)) (7)

In this case, it goes without saying that the factor k needs to be set such that V′<1. It is also possible to set the reduction ratio by multiplying the right side of Equation (6) by itself. The value of the parallax to be adjusted by the offset-distance adjustment unit 94 may be set by the changeover switch 43. The above can also be applied when the protrusion distance of the object is increased or when the enlarged trimming image is generated as described above.

As described above, the offset-distance adjustment unit 94 reduces the protrusion distance of the object by reducing the parallax of the object, and the scaling unit 96 generates a reduced trimming image by reducing the object in accordance with the protrusion distance of the object. Therefore, as illustrated in FIG. 16, the user can reduce the protrusion distance of the touched object and can virtually view the 3D image in which the size balance between the objects in the 3D image W5 is maintained.

Referring back to FIG. 9, a case at Step S115 will be explained below where the receding adjustment icon Q2 is operated (NO at Step S115). In this case, the control unit 9 determines whether the return icon Q3 (see (a) of FIG. 10), which is used for inputting a change instruction signal for returning the parallax of the object adjusted by the offset-distance adjustment unit 94 to the initial state, is operated (Step S121). When the return icon Q3 is not operated (NO at Step S121), the display apparatus 1 returns to Step S104. On the other hand, when the return icon Q3 is operated (YES at Step S121), the offset-distance adjustment unit 94 adjusts the parallax of the object to the initial state (Step S122), and the display apparatus 1 returns to Step S104.

A case at Step S104 will be explained below where the user operates the release switch 42 and the release signal for giving an instruction to capture an image is input (YES at Step S104). In this case, the display apparatus 1 captures an image that is being displayed by the display unit 6 and stores image data of the captured image in the image-data storage unit 81 of the storage unit 8 (Step S123).

The display controller 98 causes the display unit 6 to display a REC view of a 3D image corresponding to the captured image data (Step S124). Then, the control unit 9 determines whether a predetermined period of time has elapsed since display of the REC view of the captured image by the display unit 6 (Step S125). As a result of the determination by the control unit 9, when the predetermined period of time has not elapsed since the display of the REC view of the captured image by the display unit 6 (NO at Step S125), the display apparatus 1 returns to the Step S124. On the other hand, as a result of the determination by the control unit 9, when the predetermined period of time has elapsed since the display of the REC view of the captured image by the display unit 6 (YES at Step S125), the display apparatus 1 returns to Step S101.

A case at Step S102 will be explained below where the display apparatus 1 is not set to the shooting mode (NO at Step S102). In this case, the display apparatus 1 performs a playback display process for displaying the captured image data on the display unit 6 (Step S126), and thereafter returns to Step S101.

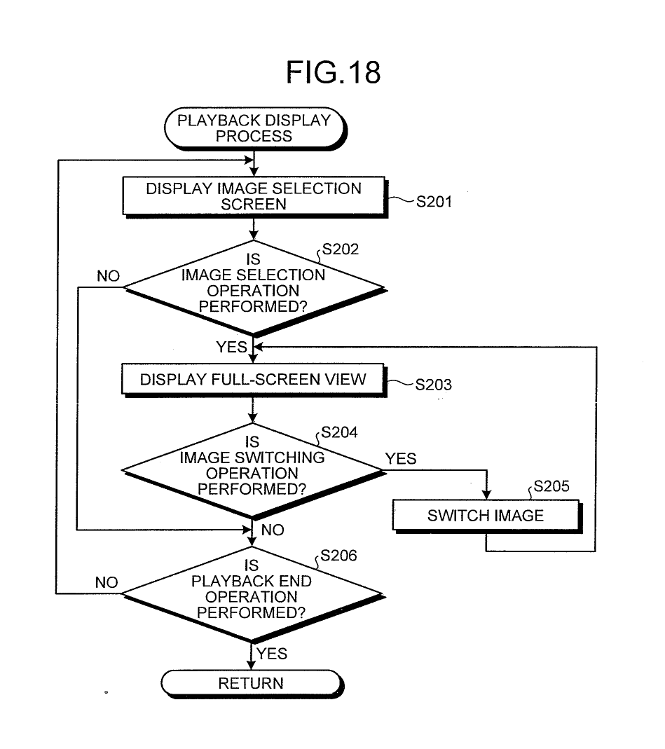

The playback display process at Step S126 in FIG. 9 will be explained below. FIG. 18 is a flowchart of an overview of the playback display process. In FIG. 18, the display controller 98 causes the display unit 6 to display an image selection screen, in which images stored in the image-data storage unit 81 are collectively displayed (Step S201).

The control unit 9 determines whether the user touches the touch panel 7 and selects any image from the image selection screen displayed by the display unit 6 (Step S202). When the user selects any image from the image selection screen (YES at Step S202), the display apparatus 1 goes to Step S203 to be described below. On the other hand, when the user does not select any image from the image selection screen (NO at Step S202), the display apparatus 1 goes to Step S206 to be described below.

A case will be explained below where the user selects any image from the image selection screen (YES at Step S202). In this case, the display controller 98 causes the display unit 6 to display a full-screen view of the 3D image selected by the user (Step S203), and determines whether the user performs an image switching operation (Step S204). When the user performs the image switching operation (YES at Step S204), the display controller 98 switches the 3D image that is being displayed by the display unit 6 (Step S205). Then, the display apparatus 1 returns to Step S203.

On the other hand, when the user does not perform the image switching operation (NO at Step S204), the control unit 9 determines whether a playback end operation is performed (Step S206). When the playback end operation is not performed (NO at Step S206), the display apparatus 1 returns to Step S201. On the other hand, when the playback end operation is performed (YES at Step S206), the display apparatus 1 returns to a main routine in FIG. 9.

According to the embodiment described above, the area selecting unit 93 selects, as the adjustment area, the object area of an object specified via the touch panel 7; the offset-distance adjustment unit 94 adjusts the parallax of the object in accordance with the change instruction signal received via the touch panel 7; and the display controller 98 causes the display unit 6 to display a 3D image by using the right-eye image and the left-eye image, for which the parallax of the object is adjusted by the offset-distance adjustment unit 94. Therefore, a user can separately adjust the degree of protrusion or receding of desired objects contained in the 3D image.

Furthermore, according to the embodiment, the trimming unit 95 generates a trimming image by trimming an object, which is specified by the input signal received by the touch panel 7, from each of the right-eye image and the left-eye image; the scaling unit 96 enlarges or reduces the trimming image to generate an enlarged trimming image or a reduced trimming image; the composite-image generating unit 97 generates a right-eye composite image and a left-eye composite image by superimposing the enlarged trimming image or the reduced trimming image onto the area of the object; and the display controller 98 causes the display unit 6 to display a 3D image by using the right-eye composite image and the left-eye composite image generated by the composite-image generating unit. Therefore, the user can virtually view a smooth 3D image in which the size balance between the objects is maintained.

### Modification of First Embodiment

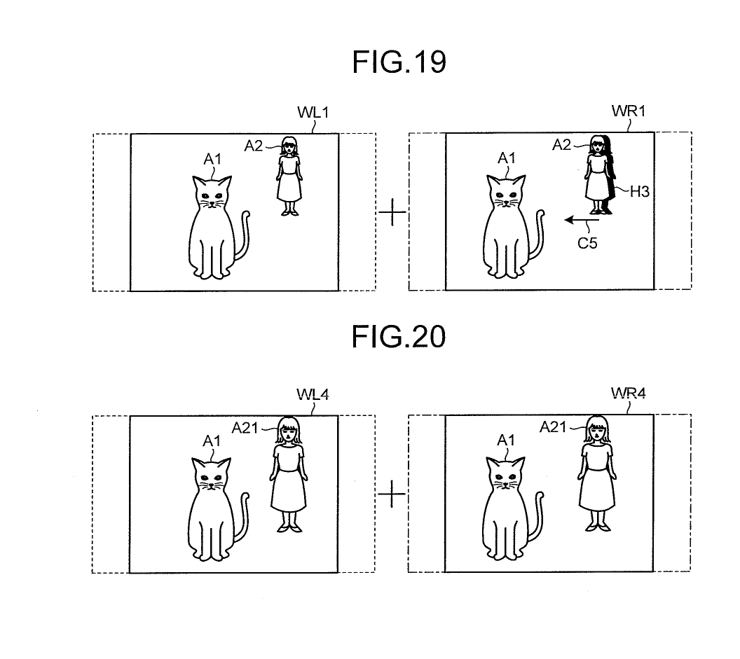

In the above explanation, an example is described in which the offset distance of the object A1 in the 3D image displayed by the display unit 6 is adjusted. However, it is possible to adjust the offset distance of the object A2 in the 3D image. FIG. 19 is a schematic diagram explaining an adjustment method for increasing the parallax of the object A2, which is performed by the offset-distance adjustment unit 94. As illustrated in FIG. 19, the offset-distance adjustment unit 94 adjusts the parallax of the object A2, which is contained in each of the right-eye image WR1 and the left-eye image WL1 generated by the stereoscopic-image generating unit 92, so that the parallax is increased by a predetermined amount. Specifically, as illustrated in FIG. 19, the offset-distance adjustment unit 94 moves the object A2 in the right-eye image WR1 by a predetermined amount in the leftward direction (along an arrow C5) so that the parallax is increased. Therefore, a user can separately increase the protrusion distance of the object A2. However, a lost area H3 (a black area in FIG. 19), in which pixels are lost, is generated in the right-eye image WR1 because the offset-distance adjustment unit 94 has moved the object A2 in the right-eye image WR1.

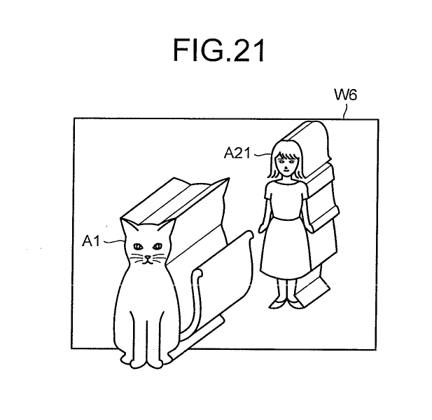

To cope with this, as illustrated in FIG. 20, the trimming unit 95 generates a trimming image by trimming the object A2 from each of the right-eye image WR1 and the left-eye image WL1, and the scaling unit 96 generates an enlarged trimming image A21 by enlarging the object A2 in each of the right-eye image WR1 and the left-eye image WL1 in accordance with the parallax of the object A2 and the protrusion distance of the object A2, which are adjusted by the offset-distance adjustment unit 94. Thereafter, the composite-image generating unit 97 generates a right-eye composite image WR4 and a left-eye composite image WL4 by superimposing the enlarged trimming image A21 generated by the scaling unit 96 onto the areas of the object A2. The display controller 98 then causes the display unit 6 to display a 3D image (see an image W6 in FIG. 21) by using the right-eye composite image WR4 and the left-eye composite image WL4.

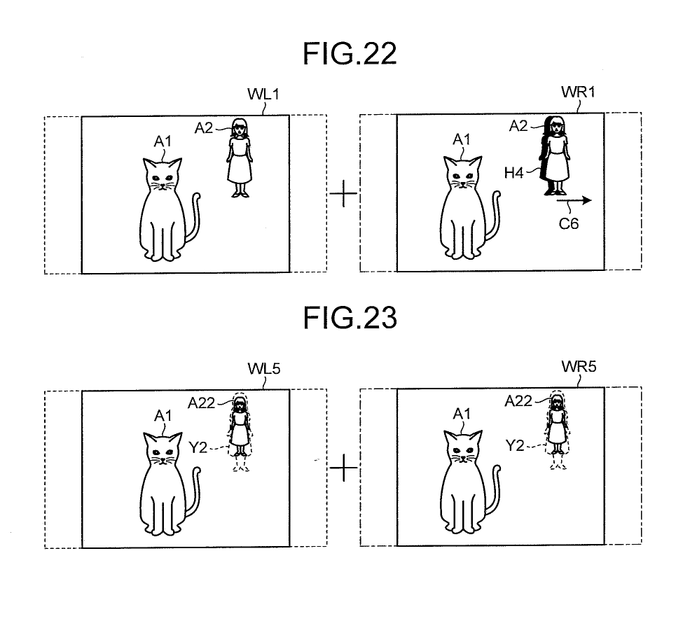

Furthermore, as illustrated in FIG. 22, the offset-distance adjustment unit 94 adjusts the parallax of the object A2, which is contained in each of the right-eye image WR1 and the left-eye image WL1 generated by the stereoscopic-image generating unit 92, so that the parallax is reduced by a predetermined amount. Specifically, as illustrated in FIG. 22, the offset-distance adjustment unit 94 moves the object A2 in the right-eye image WR1 by a predetermined amount in the rightward direction (along an arrow C6) so that the parallax is reduced. Therefore, the user can separately reduce the protrusion distance of the object A2. However, the user may feel discomfort because a balance of depth is disturbed between the object A1 and the object A2 in the 3D image that the user virtually views. Furthermore, similarly to Step S122 described above, a lost area H4 (a black area in FIG. 22), in which pixels are lost, is generated.

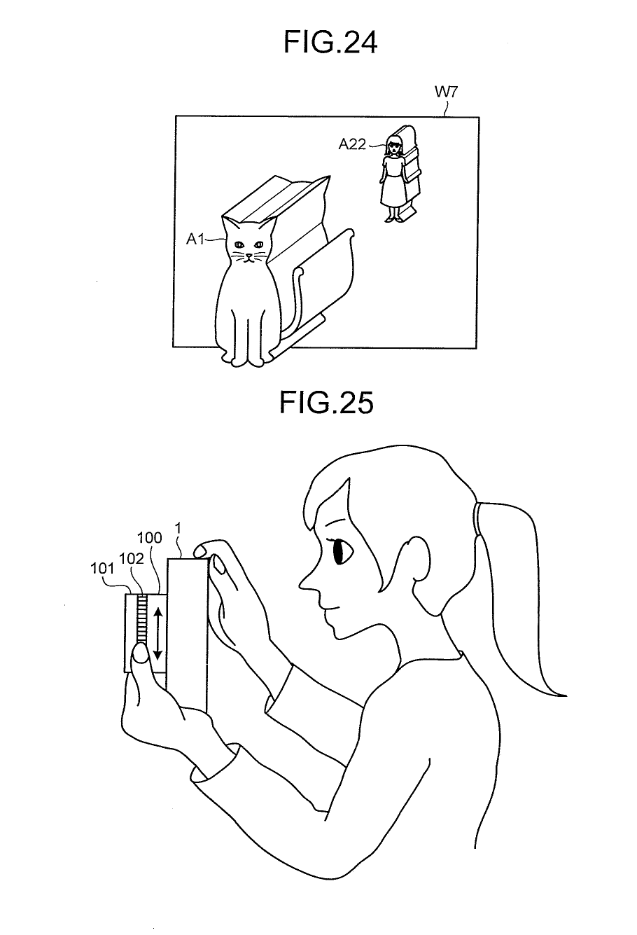

To cope with this, as illustrated in FIG. 23, the trimming unit 95 generates a trimming image by trimming the object A2 from each of the right-eye image WR1 and the left-eye image WL1, and the scaling unit 96 generates a reduced trimming image A22 by reducing the trimming image of each of the right-eye image WR1 and the left-eye image WL1 in accordance with the parallax of the object A2 and the protrusion distance of the object A2, which are adjusted by the offset-distance adjustment unit 94. Then, the composite-image generating unit 97 generates a right-eye composite image WR5 and a left-eye composite image WL5 by superimposing the reduced trimming image A22 generated by the scaling unit 96 onto the areas of the object A2 and by interpolating an area Y2 by performing a known interpolation process on the lost area H4. Subsequently, the display controller 98 causes the display unit 6 to display a 3D image (see an image W7 in FIG. 24) by using the right-eye composite image WR5 and the left-eye composite image WL5.

As described above, the user can adjust the protrusion distance of the touched object A2 in the 3D image displayed by the display unit 6 and can virtually view a smooth 3D image.

In the first embodiment, the offset-distance adjustment unit 94 adjusts the parallax of the specified object in the 3D image in response to the operation of the depth icon that is arranged in the 3D image displayed by the display unit 6. However, it is possible to adjust the parallax of the object in response to the operation of the other switches. FIG. 25 is a diagram illustrating a user adjusting the parallax of an object in a 3D image in the display apparatus according to the modification of the first embodiment of the present invention. As illustrated in FIG. 25, the display apparatus 1 includes a lens unit 100. The lens unit 100 is detachable from a main body of the display apparatus 1. The lens unit 100 includes two imaging units 101 that capture images at different positions and that have respective fields of view in which right-side and left-side portions overlap each other; and an input unit 102 that receives input of a change instruction signal for changing the offset distance of the adjustment area selected by the area selecting unit 93. The offset-distance adjustment unit 94 adjusts the parallax of the object, which is specified via the touch panel 7, in accordance with the operating time or the operating amount of the input unit 102. Therefore, a user can adjust the offset distance of a desired object in the 3D image by enjoyable mechanical operations. The offset-distance adjustment unit 94 may adjust the parallax of the object, which is specified via the touch panel 7, in accordance with an operation signal according to the zoom switch 44.

In the first embodiment, when the offset-distance adjustment unit 94 reduces the parallax of the object specified via the touch panel 7, the scaling unit 96 generates a reduced trimming image by reducing the trimming image; however, it is possible to generate an enlarged trimming image by enlarging the trimming image.

In the first embodiment, the area selecting unit 93 selects, as the adjustment area, an object that the user touches in the 3D image displayed by the display unit 6. However, it is possible to set the adjustment area in accordance with, for example, a contact trajectory of an external object on the touch panel 7. In this case as well, the user can adjust the offset distance of a desired area in the 3D image.

In the first embodiment, the offset-distance adjustment unit 94 adjusts the parallax of the object after the object is specified via the touch panel 7. However, it is possible to adjust the parallax of the object after the user operates the depth icon and then touches the object in the 3D image.

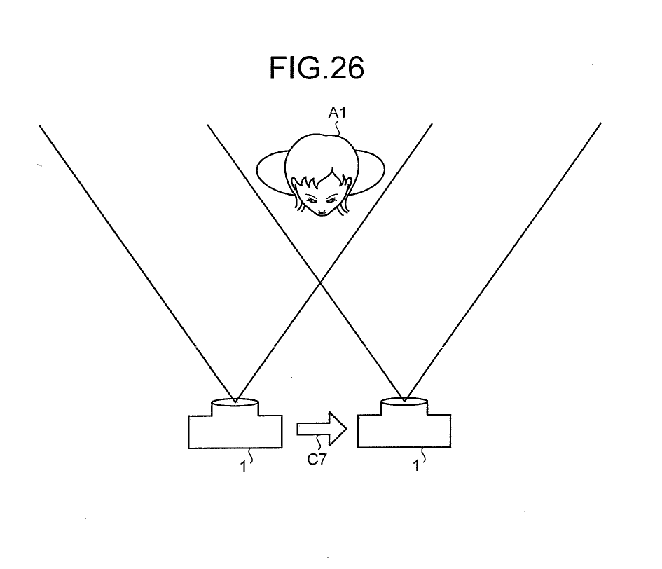

In the first embodiment, the imaging unit 2 generates two pieces of image data, in which right-side and left-side portions of respective fields of view overlap each other. However, it is possible to provide only one imaging unit such that the imaging unit 2 successively captures images in order to generate the two pieces of image data, in which right-side and left-side portions of the respective fields of view overlap each other. Specifically, as illustrated in FIG. 26, it is possible to generate the two pieces of image data, in which right-side and left-side portions of the respective fields of view overlap each other, by successively capturing images of the object A1 while the user moves the display apparatus 1 from left to right (along an arrow C7).

In the first embodiment, the imaging unit 2 generates the two pieces of image data, in which right-side and left-side portions of the respective fields of view overlap each other. However, it is possible to provide only one imaging element and focus light in the imaging area of the one imaging element by using two optical systems in order to generate the two pieces of image data, in which right-side and left-side portions of the respective fields of view overlap each other.

In the first embodiment, the posture detecting unit 3 detects the posture of the display apparatus 1. However, it is possible to detect acceleration that occurs when a user taps the display screen of the display unit 6, receive an operation signal of the tap operation for switching between various shooting mode and various settings of the display apparatus 1, and output the operation signal to the control unit 9.

In the first embodiment, the offset-distance adjustment unit 94 performs the processes while images are being captured. However, the processes may be performed on images that are displayed as REC view by the display unit 6 just after the images are captured or on images that are played in accordance with image data stored in the image-data storage unit 81.

### Second Embodiment

A second embodiment of the present invention will be explained below. A display apparatus according to the second embodiment is different from that of the first embodiment in that a storage unit and a control unit are configured differently. In addition, the display apparatus according to the second embodiment operates differently from that of the first embodiment. Therefore, in the following, the configurations of the storage unit and the control unit of the display apparatus according to the second embodiment will be explained first, and thereafter, the operation of the display apparatus of the second embodiment will be explained. In the drawings, the same components are denoted by the same reference numerals.

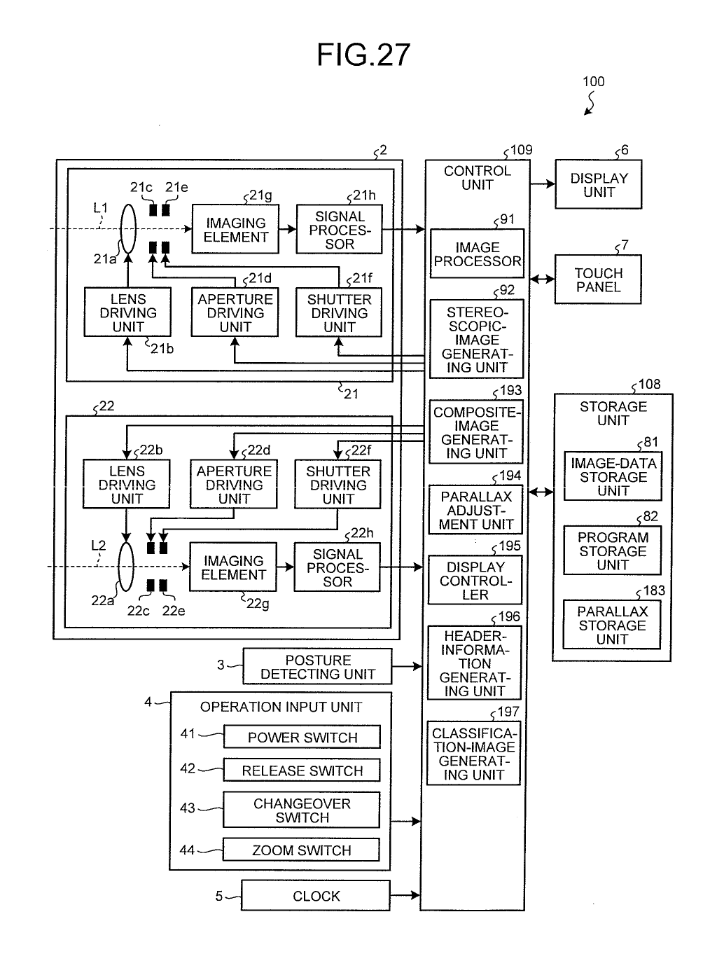

FIG. 27 is a block diagram of a configuration of the display apparatus according to the second embodiment of the present invention. As illustrated in FIG. 27, a display apparatus 100 includes the imaging unit 2, the posture detecting unit 3, the operation input unit 4, the clock 5, the display unit 6, the touch panel 7, a storage unit 108, and a control unit 109.

The storage unit 108 includes the image-data storage unit 81, the program storage unit 82, and a parallax storage unit 183. The parallax storage unit 183 stores therein a comfortable range of a parallax of a 3D image displayed by the display unit 6.

The control unit 109 is realized by a CPU or the like. The control unit 109 reads and executes programs stored in the program storage unit 82 of the storage unit 108 in accordance with an operation signal or the like received from the operation input unit 4 and sends instructions or data to each unit of the display apparatus 100 to thereby control the overall operation of the display apparatus 100.

The detailed configuration of the control unit 109 will be explained below. The control unit 109 includes the image processor 91, the stereoscopic-image generating unit 92, a composite-image generating unit 193, a parallax adjustment unit 194, a display controller 195, a header-information generating unit 196, and a classification-image generating unit 197.

The composite-image generating unit 193 generates a composite image by superimposing the left-eye image and the right-eye image that are generated by the stereoscopic-image generating unit 92. Specifically, the composite-image generating unit 193 generates a composite image by matching and superimposing an area having the highest sharpness in an image area of the left-eye image and an area having the highest sharpness in an image area of the right-eye image. Therefore, the composite-image generating unit 193 can generate a composite image with reference to an object that is in focus in the image area of each of the left-eye image and the right-eye image.

The parallax adjustment unit 194 adjusts the parallax of an object contained in the composite image by changing a trimming area, which is trimmed from each of left-eye image data and right-eye image data by the stereoscopic-image generating unit 92, in accordance with a contact trajectory of an object on the touch panel 7. Specifically, the parallax adjustment unit 194 adjusts the parallax of the object contained in the composite image by, for example, shifting an area of the right-eye image, which is contained in an area where the right-side and left-side portions of the left-eye image and the right-eye image overlap each other in the composite image, in the rightward direction in accordance with the contact trajectory of an object on the touch panel 7.

The display controller 195 causes the display unit 6 to display a 3D image or a 2D image. Specifically, when causing the display unit 6 to display a 3D image, the display controller 195 causes the display unit 6 to output a 3D image, in which the left-eye image and the right-eye image of the 3D image generated by the stereoscopic-image generating unit 92 are alternately aligned one pixel by one pixel in the horizontal direction of the display screen of the display unit 6. On the other hand, when causing the display unit 6 to display a 2D image, the display controller 195 changes the power supply to the parallax barrier 63 from the ON state to the OFF state in order to switch the parallax barrier 63 of the display unit 6 from the light-blocking state to the transmissive state and outputs only one of the left-eye image and the right-eye image to the display panel 62. Furthermore, the display controller 195 causes the display unit 6 to display the composite image, which is adjusted by the parallax adjustment unit 194, and parallax information relating to the parallax of the object contained in the composite image. When the parallax of the object contained in the composite image adjusted by the parallax adjustment unit 194 exceeds a predetermined parallax, the display controller 195 causes the display unit 6 to display warnings and to display the composite image with a predetermined fixed parallax of the object.

The header-information generating unit 196 generates, as header information of two pieces of image data, the parallax of the object contained in the composite image adjusted by the parallax adjustment unit 194 and stores the header information in the image-data storage unit 81 in association with the image data generated by the imaging unit 2.

The classification-image generating unit 197 generates a classification image, in which pieces of image data are classified for each parallax, by referring to the header information stored in the image-data storage unit 81.

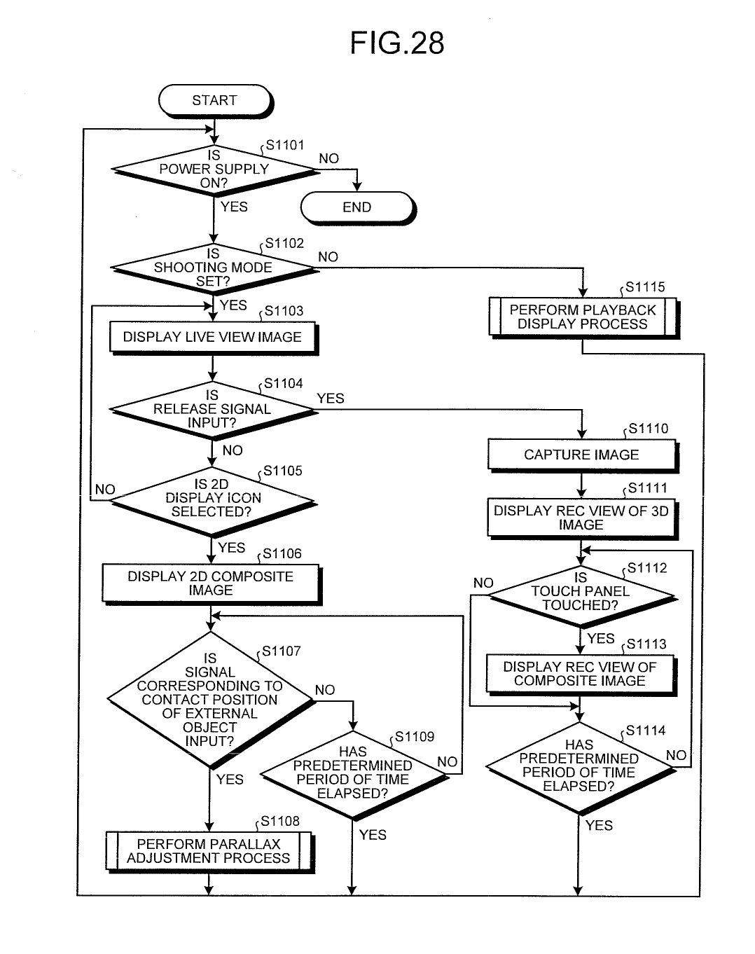

A process performed by the display apparatus 100 according to the second embodiment will be explained below. FIG. 28 is a flowchart of an overview of the process performed by the display apparatus 100.

In FIG. 28, the control unit 109 determines whether the power supply to the display apparatus 100 is on (Step S1101). When the power supply to the display apparatus 100 is on (YES at Step S1101), the display apparatus 100 goes to Step S1102. On the other hand, when the power supply to the display apparatus 100 is not on (NO at Step S1101), the display apparatus 100 ends the process.

The control unit 109 determines whether the display apparatus 100 is set to a shooting mode (Step S1102). When the control unit 109 determines that the display apparatus 100 is set to the shooting mode (YES at Step S1102), the display apparatus 100 goes to Step S1103. On the other hand, when the control unit 109 determines that the display apparatus 100 is not set to the shooting mode (NO at Step S1102), the display apparatus 100 goes to Step S1115 to be described below.

A case will be explained below where the display apparatus 100 is set to the shooting mode (YES at Step S1102). In this case, the display controller 195 causes the display unit 6 to display a live view image of a 3D image corresponding to pieces of image data that the imaging unit 2 has sequentially generated at predetermined small time intervals (Step S1103).

The control unit 109 determines whether a user operates the release switch 42 and a release signal for giving an instruction to capture an image is input (Step S1104). When the release signal for giving the instruction to capture an image is input (YES at Step S1104), the display apparatus 100 goes to Step S1110 to be described below. On the other hand, when the release signal for giving the instruction to capture an image is not input (NO at Step S1104), the display apparatus 100 goes to Step S1105 to be described below.

A case will be explained below where the release signal for giving the instruction to capture an image is not input (NO at Step S1104). In this case, the control unit 109 determines whether a 2D display icon is selected (Step S1105). Specifically, the control unit 109 determines whether a user presses the 2D display icon (not illustrated) that is arranged in the image displayed by the display unit 6 and that is used for inputting a changeover signal for switching the display mode of the display unit 6 from 3D image display to 2D image display. When the user does not select the 2D image icon (NO at Step S1105), the display apparatus 100 returns to Step S1103. On the other hand, when the user selects the 2D image icon (YES at Step S1105), the display apparatus 100 goes to Step S1106.

At Step S1106, the display controller 195 causes the display unit 6 to display a composite image that is a 2D image generated by the composite-image generating unit 193. In this case, the display controller 195 changes the power supply to the parallax barrier 63 from the ON state to the OFF state in order to switch the parallax barrier 63 from the light-blocking state to the transmissive state. Consequently, the user can view the composite image displayed by the display unit 6 as the 2D image.

Thereafter, the control unit 109 determines whether a signal that corresponds to a contact position of an external object on the touch panel 7 is input (Step S1107). When the signal corresponding to the contact position of the external object on the touch panel 7 is input (YES at Step S1107), the display apparatus 100 performs a parallax adjustment process for adjusting a protrusion distance or a receding distance of an object contained in the composite image (Step S1108) and thereafter returns to Step S1101.

On the other hand, when the signal corresponding to the contact position of the external object on the touch panel 7 is not input (NO at Step S1107), the control unit 109 determines whether a predetermined period of time has elapsed since the display of the 2D image by the display unit 6 (Step S1109). When the predetermined period of time has not elapsed since the display of the 2D image by the display unit 6 (NO at as S1109), the display apparatus 100 returns to Step S1107. On the other hand, when the predetermined period of time has elapsed since the display of the 2D image by the display unit 6 (YES at Step S1109), the display apparatus 100 returns to Step S1101.

A case at Step S1104 will be explained below where the user operates the release switch 42 and the release signal for giving the instruction to capture an image is input (YES at Step S1104). In this case, the imaging unit 2 captures an image that is being displayed by the display unit 6 and stores image data of the captured image in the image-data storage unit 81 of the storage unit 108 (Step S1110).

The display controller 195 causes the display unit 6 to display a REC view of a 3D image corresponding to the image data of the image captured by the imaging unit 2 (Step S1111). Consequently, the user can check the degree of depth of the captured image.

Thereafter, the control unit 109 determines whether the user touches the touch panel 7 (Step S1112). When the user touches the touch panel 7 (YES at Step S1112), the display controller 195 changes the display mode of the display unit 6 from the 3D image to the 2D image and displays a REC view of a composite image (Step S1113). Specifically, the display controller 195 causes the display unit 6 to display the composite image generated by the composite-image generating unit 193. Consequently, the user can easily see the parallax of the object contained in the captured image and can intuitively recognize the protrusion distance or the receding distance of the object.

On the other hand, when the user does not touch the touch panel 7 (NO at Step S1112), the control unit 109 determines whether a predetermined period of time has elapsed since the display of the REC view of the captured image by the display unit 6 (Step S1114). As a result of the determination by the control unit 109, when the predetermined period of time has elapsed since the display of the REC view of the captured image by the display unit 6 (NO at Step S1114), the display apparatus 100 returns to Step S1112. On the other hand, as a result of the determination by the control unit 109, when the predetermined period of time has elapsed since the display of the REC view of the captured image by the display unit 6 (YES at Step S1114), the display apparatus 100 returns to Step S1101.

A case at Step S1102 will be explained below where the display apparatus 100 is not set to the shooting mode (NO at Step S1102). In this case, the display apparatus 100 performs a playback display process for displaying the captured image on the display unit 6 (Step S1115) and thereafter returns to Step S1101.

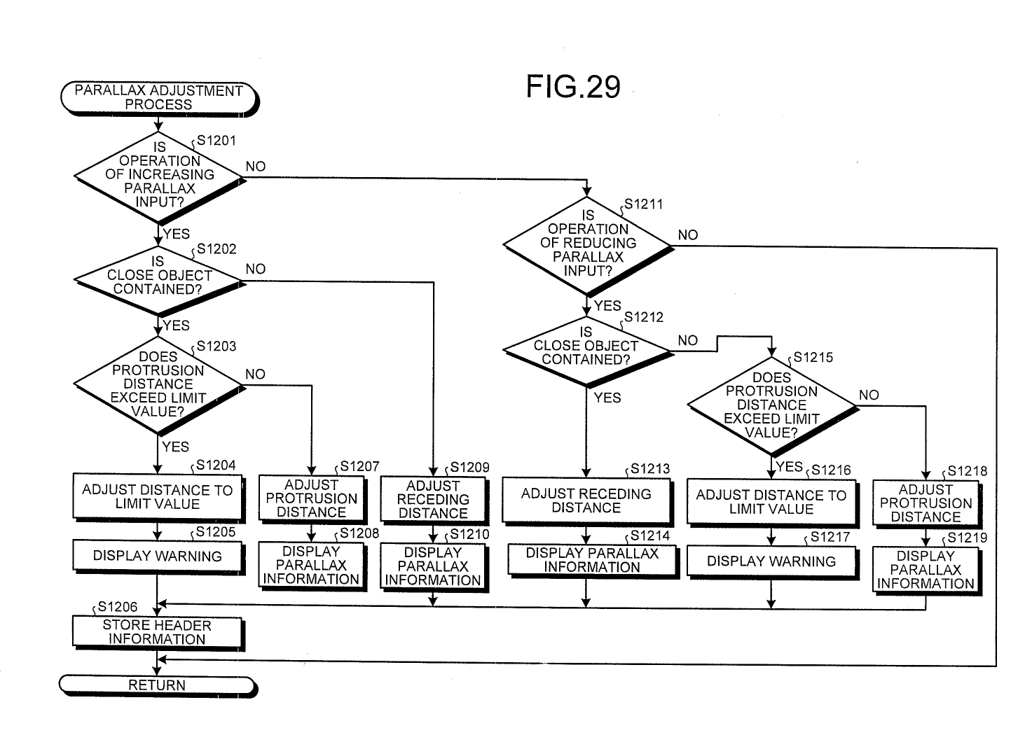

The parallax adjustment process performed at Step S1108 will be explained below. FIG. 29 is a flowchart of an overview of the parallax adjustment process.

In FIG. 29, the control unit 109 determines whether the contact trajectory of the object on the touch panel 7 corresponds to an operation of increasing the parallax of an object contained in the composite image (Step S1201). When the contact trajectory of the object on the touch panel 7 corresponds to the operation of increasing the parallax of the object contained in the composite image (YES at Step S1201), the display apparatus 100 goes to Step S1202 to be described below. On the other hand, when the contact trajectory of the object on the touch panel 7 does not correspond to the operation of increasing the parallax of the object contained in the composite image (NO at Step S1201), the display apparatus 100 goes to Step S1211.

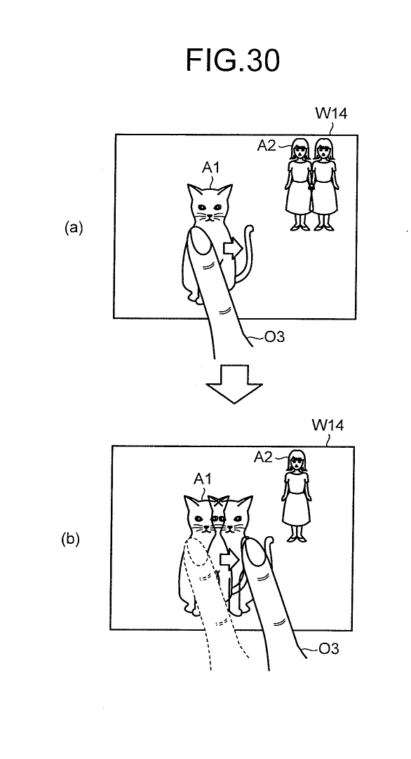

FIG. 30 is a diagram explaining a user operation for increasing the parallax of an object contained in the composite image.

As illustrated in FIG. 30, when the user moves a finger O3 touching the touch panel 7 from the left side to the right side of an image W14 in the area of the object A1 that does not have a parallax in the image W14 being displayed by the display unit 6 ((a)→(b) of FIG. 30), the control unit 109 determines that this operation corresponds to the operation of increasing the parallax of the object.

At Step S1202, the control unit 109 determines whether a close object is contained in an image corresponding to the area of the touch panel that is firstly touched by the user with the finger. The close object is an object that is located at the closest imaging distance from the imaging unit 2 when the user captures images of a plurality of objects by using the display apparatus 1 (see FIG. 6).

Specifically, as illustrated in FIG. 30, it is determined whether the object A1 is contained in the image corresponding to the area of the touch panel 7 that is firstly touched by the user with the finger O3. When the close object is contained in the image corresponding to the area of the touch panel 7 that is firstly touched by the user with the finger O3 (YES at Step S1202), the display apparatus 100 goes to Step S1203.

At Step S1203, the control unit 109 determines whether the parallax adjustment unit 194 adjusts the parallax of the object contained in the composite image displayed by the display unit 6 in accordance with the contact trajectory of the object on the touch panel 7 and whether the protrusion distance of the object after the adjustment exceeds the limit value of the protrusion distance stored in the parallax storage unit 183. When the protrusion distance of the object set by the parallax adjustment unit 194 exceeds the limit value of the protrusion distance (YES at Step S1203), the parallax adjustment unit 194 changes a trimming area, which is trimmed from each of the right-eye image data and the left-eye image data by the stereoscopic-image generating unit 92, so that the parallax of the object contained in the composite image can be fixed at the limit value, and adjusts the protrusion distance of the object to the limit value (Step S1204).

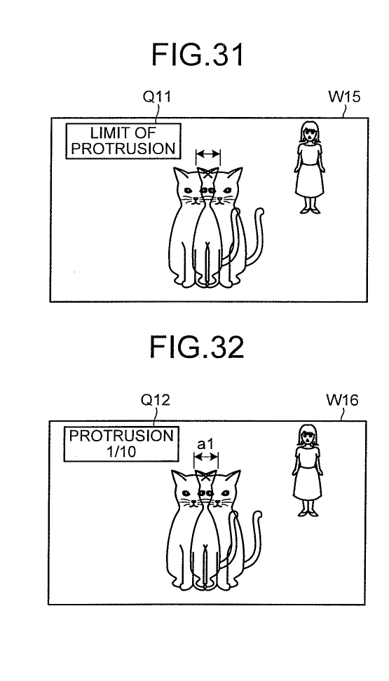

Subsequently, the display controller 195 causes the display unit 6 to display a warning, which indicates that the protrusion distance of the object exceeds the limit value, in the composite image displayed by the display unit 6 (Step S1205). Specifically, as illustrated in FIG. 31, the display controller 195 causes the display unit 6 to display, in an image W15, an icon Q11 for giving the user a warning indicating that the parallax reaches the limit. Therefore, the user can recognize the limit of the protrusion distance of the object and it is possible to prevent the object image from protruding beyond the ability of humans' eyes for viewing. The display controller 195 may display a warning when the user performs wrong operations, for example, when a direction for adjusting the parallax of the object is opposite.

Thereafter, the header-information generating unit 196 stores the parallax of the object contained in the composite image adjusted by the parallax adjustment unit 194, as header information for each of the right-eye image data and the left-eye image data (Step S1206). The display apparatus 100 then returns to the main routine in FIG. 28.

A case at Step S1203 will be explained below where the parallax of the object, which is contained in the composite image displayed by the display unit 6 after the trimming areas of the right-eye image data and the left-eye image data are adjusted by the parallax adjustment unit 194 in accordance with the contact trajectory of the object on the touch panel 7, does not exceed the limit value of the parallax stored in the parallax storage unit 183 (NO at Step S1203). In this case, the parallax adjustment unit 194 changes the trimming area, which is trimmed from each of the right-eye image data and the left-eye image data by the stereoscopic-image generating unit 92, in accordance with the contact trajectory of the object on the touch panel 7 and adjusts the parallax of the object contained in the composite image, so that the protrusion distance of the object is adjusted (Step S1207).

Thereafter, the display controller 195 displays parallax information of the object, which is adjusted by the parallax adjustment unit 194, in the composite image displayed by the display unit 6 (Step S1208). Specifically, as illustrated in FIG. 32, the display controller 195 causes the display unit 6 to display an icon Q12 in an image W16. The icon Q12 is an icon for notifying the user of protrusion distance information on the object corresponding to the parallax information on the object adjusted by the parallax adjustment unit 194. Therefore, the user can easily recognize the parallax of the object adjusted through the operation. After Step S1208, the display apparatus 100 goes to Step S1206.

A case at Step S1202 will be explained below where the close object is not contained in the image corresponding to the area of the touch panel 7 that is firstly touched by the user with the finger O3 (NO at Step S1202). In this case, the parallax adjustment unit 194 changes the trimming area, which is trimmed from each of the right-eye image data and the left-eye image data by the stereoscopic-image generating unit 92, in accordance with the contact trajectory of the object on the touch panel 7 and adjusts the parallax of the object contained in the composite image, so that the receding distance of the object is adjusted (Step S1209).

Thereafter, the display controller 195 causes the display unit 6 to display the parallax of the object set by the parallax adjustment unit 194 in the composite image displayed by the display unit 6 (Step S1210), and the display apparatus 100 goes to Step S1206.

A case at Step S1201 will be explained below where the contact trajectory of the object on the touch panel 7 does not correspond to the operation of increasing the parallax of the object contained in the composite image (NO at Step S1201). In this case, the control unit 109 determines whether the contact trajectory of the object on the touch panel 7 corresponds to an operation of reducing the parallax of the object contained in the composite image (Step S1211). When the contact trajectory of the object on the touch panel 7 does not correspond to the operation of reducing the parallax of the object contained in the composite image (NO at Step S1211), the display apparatus 100 returns to the main routine in FIG. 28. On the other hand, when the contact trajectory of the object on the touch panel 7 corresponds to the operation of reducing the parallax of the object contained in the composite image (YES at Step S1211), the display apparatus 100 goes to Step S1212.

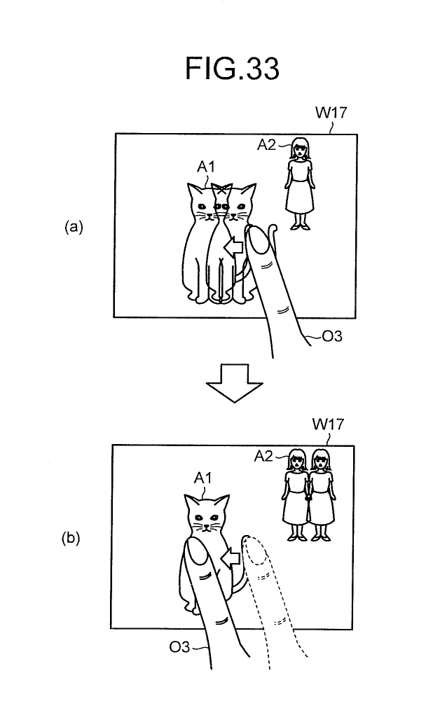

FIG. 33 is a diagram explaining a user operation for reducing the parallax of an object contained in a composite image. As illustrated in FIG. 33, when the user moves the finger O3 touching the touch panel 7 from the right side to the left side of an image W17 in the area of the object that has a parallax in the image being displayed by the display unit 6 ((a)→(b) of FIG. 33), the control unit 109 determines that this operation corresponds to the operation of reducing the parallax of the object.

At Step S1212, the control unit 109 determines whether the close object is contained in an image corresponding to the area of the touch panel 7 that is firstly touched by the user with the finger O3. When the close object is contained in the image corresponding to the area of the touch panel 7 that is firstly touched by the user with the finger O3 (YES at Step S1212), the parallax adjustment unit 194 changes the trimming area, which is trimmed from each of the right-eye image data and the left-eye image data to by the stereoscopic-image generating unit 92, in accordance with the contact trajectory of the object on the touch panel 7 and adjusts the parallax of the object contained in the composite image, so that the receding distance of the object is adjusted (Step S1213). Then, the display apparatus 100 goes to Step S1214.

At Step S1214, the display controller 195 displays receding distance information, which corresponds to the parallax information on the object set by the parallax adjustment unit 194, in the composite image displayed by the display unit 6. Thereafter, the display apparatus 100 goes to Step S1206.

A case at Step S1212 will be explained below where the close object is not contained in the image corresponding to the area of the touch panel 7 that is firstly touched by the user with the finger O3 (NO at Step S1212). In this case, the control unit 109 determines whether the parallax of the object, which is contained in the composite image displayed by the display unit 6 and adjusted by the parallax adjustment unit 194 in accordance with the contact trajectory of the object on the touch panel 7, exceeds the limit value of the parallax stored in the parallax storage unit 183 (Step S1215). When the parallax of the object contained in the composite image adjusted by the parallax adjustment unit 194 exceeds the limit value of the parallax stored in the parallax storage unit 183 (YES at Step S215), the parallax adjustment unit 194 fixes the parallax of the object contained in the composite image to the limit value and changes the trimming area, which is trimmed from each of the right-eye image data and the left-eye image data by the stereoscopic-image generating unit 92, and adjusts the parallax of the object contained in the composite image, so that the protrusion distance of the object is adjusted to the limit value (Step S1216).

Subsequently, the display controller 195 causes the display unit 6 to display a warning, which indicates that the parallax of the object reaches the limit value, in the composite image displayed by the display unit 6 (Step S1217), and the display apparatus 100 goes to Step S1206.

A case at Step S1215 will be explained below where the parallax of the object, which is contained in the composite image and which is adjusted by the parallax adjustment unit 194 in accordance with the contact trajectory of the object, does not exceed the limit value of the parallax stored in the parallax storage unit 183 (NO at Step S1215). In this case, the parallax adjustment unit 194 changes the trimming area, which is trimmed from each of the right-eye image data and the left-eye image data by the stereoscopic-image generating unit 92, in accordance with the contact trajectory of the object on the touch panel 7 and adjusts the parallax of the object contained in the composite image, so that the protrusion distance of the object is adjusted (Step S1218). Then, the display apparatus 100 goes to Step S1219.

At Step S1219, the display controller 195 causes the display unit 6 to display the protrusion distance of the object set by the parallax adjustment unit 194 in the composite image displayed by the display unit 6. Then, the display apparatus 100 goes to Step S1206.

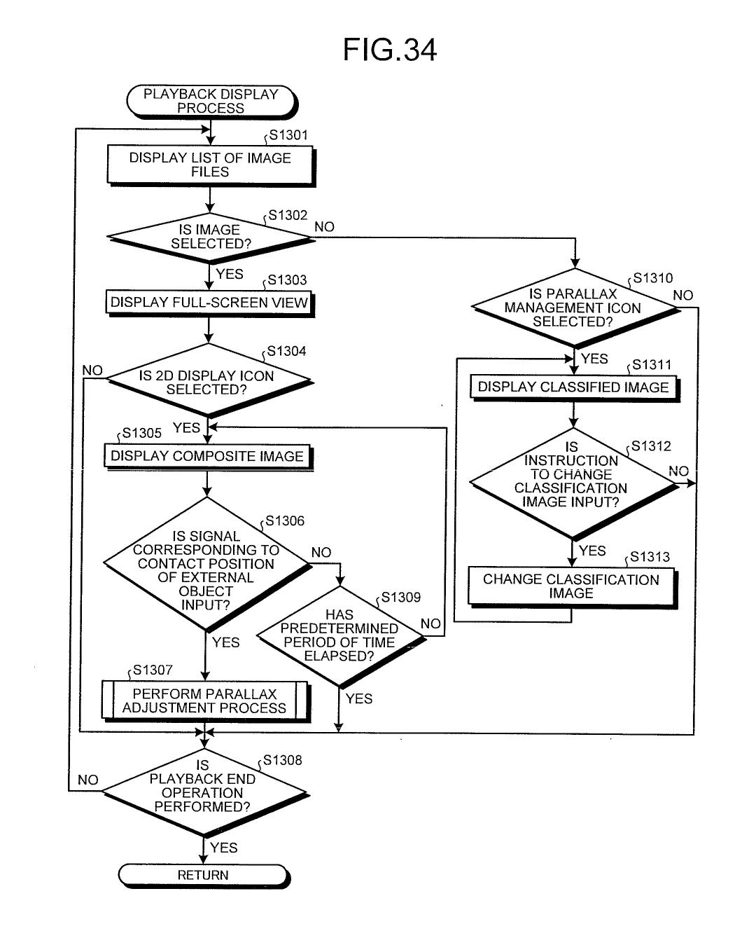

The playback display process at Step S1115 in FIG. 28 will be explained below. FIG. 34 is a flowchart of an overview of the playback display process.

In FIG. 34, the display controller 195 causes the display unit 6 to display an image selection screen, in which images stored in the image-data storage unit 81 are collectively displayed (Step S1301).

The control unit 109 determines whether the user operates the touch panel 7 and selects any image from the image selection screen displayed by the display unit 6 (Step S1302). When the user selects any image from the image selection screen (YES at Step S1302), the display apparatus 100 goes to Step S1303 to be described below. On the other hand, when the user does not select any image from the image selection screen (NO at Step S1302), the display apparatus 100 goes to Step S1310 to be described below.

A case will be explained below where the user selects the image from the image selection screen (YES at Step S1302). In this case, the display controller 195 causes the display unit 6 to display a full-screen view of the 3D image selected by the user (Step S1303), and then the display apparatus 100 goes to Step S1304.

Subsequently, the control unit 109 determines whether the user selects a 2D display icon (Step S1304). When the user does not select the 2D display icon (NO at Step S1304), the display apparatus 100 goes to Step S1308. On the other hand, when the user selects the 2D display icon (YES at Step S1304), the display apparatus 100 goes to Step S1305.

At Step S1305, the display controller 195 causes the display unit 6 to display a composite image, which is generated by the composite-image generating unit 193 by using the right-eye image data and the left-eye image data that correspond to the 3D image being displayed on the display unit 6.

The control unit 109 determines whether a signal corresponding to a contact position of an external object on the touch panel 7 is input (Step S1306). When the signal corresponding to the contact position of the external object on the touch panel 7 is input (YES at Step S1306), the display apparatus 100 performs the parallax adjustment process for adjusting the parallax of the object contained in the composite image as explained above with reference to FIG. 28 (Step S1307). When a playback end operation is not performed (NO at Step S1308), the display apparatus 100 returns to Step S1301. On the other hand, when the playback end operation is performed (YES at Step S1308), the display apparatus 100 returns to the main routine in FIG. 28.

At Step S1306, when the signal corresponding to the contact position of the external object on the touch panel 7 is not input (NO at Step S1306), the control unit 109 determines whether a predetermined period of time has elapsed since the display of the composite image by the display unit 6 (Step S1309). When the predetermined period of time has not elapsed since the display of the composite image by the display unit 6 (NO at Step S1309), the display apparatus 100 returns to Step S1305. On the other hand, when the predetermined period of time has elapsed since the display of the composite image by the display unit 6 (YES at Step S1309), the display apparatus 100 goes to Step S1308.

At Step S1302, when the user does not select any image from the image selection screen (NO at Step S1302), the control unit 109 determines whether a parallax management icon, which is used for inputting a parallax management signal for displaying the classification image generated by the classification-image generating unit 197, is selected (Step S1310). Specifically, the control unit 109 determines whether the user selects the parallax management icon (not illustrated) that is displayed together with the image selection screen. When the parallax management icon is not selected (NO at Step S1310), the display apparatus 100 goes to Step S1308. On the other hand, when the parallax management icon is selected (YES at Step S1310), the display apparatus 100 goes to Step S1311.

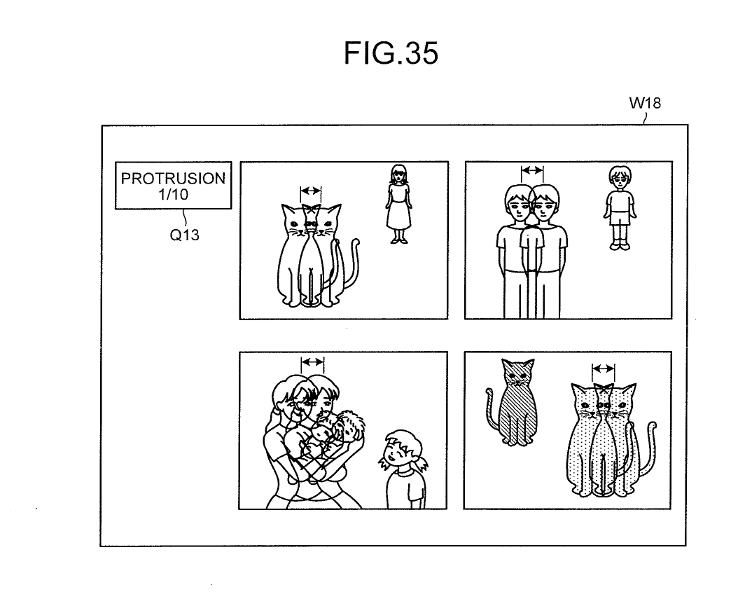

At Step S1311, the display controller 195 causes the display unit 6 to display the classification image generated by the classification-image generating unit 197. Specifically, as illustrated in FIG. 35, the display controller 195 causes the display unit 6 to display a classification image W18, in which pieces of image data are classified for each parallax and which is generated by the classification-image generating unit 197, as a 2D image. An icon Q13 in the classification image W18 is an icon that indicates parallax information on the classification image. Therefore, the user can determine the degree of protrusion or receding of images on the basis of the stored information on the images that have been displayed by the display unit 6 or other display monitors. As a result, when the user captures images next time by using the display apparatus 100, the user can capture the images by taking into account the sizes of the other display monitors.

At Step S1312, the control unit 109 determines whether the user operates the changeover switch 43 so that an instruction signal for changing the classification image that is being displayed by the display unit 6 is input. When the instruction signal for changing the classification image is input (YES at Step S1312), the display controller 195 changes the classification image displayed by the display unit 6 (Step S1313), and thereafter, the display apparatus 100 returns to Step S1311. On the other hand, when the instruction signal for changing the classification image is not input (NO at Step S1312), the display apparatus 100 goes to Step S1308.

According to the second embodiment described above, the parallax adjustment unit 194 adjusts the parallax of the object, which is contained in the composite image displayed by the display unit 6, by changing the trimming area that is trimmed from each of the right-eye image data and the left-eye image data by the stereoscopic-image generating unit 92, in accordance with the contact trajectory of an object on the touch panel 7. In addition, the display controller 195 causes the display unit 6 to display the composite image adjusted by the parallax adjustment unit 194. Therefore, the user can adjust the amount of change in the 3D image by intuitive operations while viewing the image displayed by the display unit 6. Furthermore, the composite-image generating unit 193 generates a composite image with reference to the close object that is in focus in the image area of each of the left-eye image and the right-eye image. Therefore, the user can adjust the amount of change in the 3D image from the state where the parallax of the close object contained in the composite image is small.

### Modification of Second Embodiment

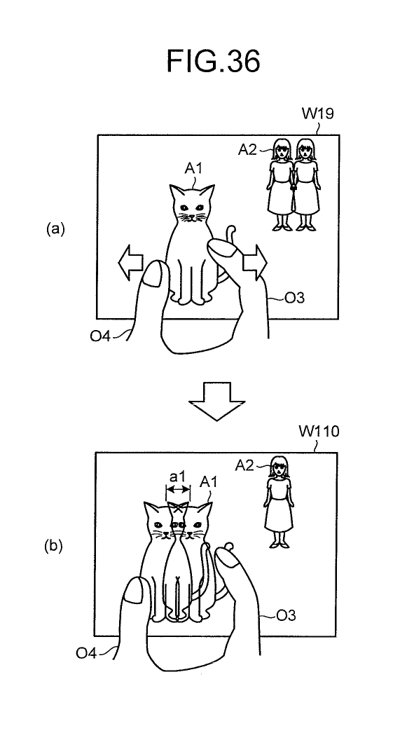

In the second embodiment described above, the parallax adjustment unit 194 may adjust the parallax of the object contained in the composite image by changing trimming areas of two pieces of image data in accordance with contact trajectories of two external objects on the touch panel 7. Specifically, as illustrated in FIG. 36, the parallax adjustment unit 194 may adjust the parallax of the object A1 contained in an image W19 in accordance with the trajectories of the finger O3 and a finger O4 of a user. In this case, the control unit 109 compares positions where the fingers O3 and O4 firstly touch the touch panel 7 and positions where the fingers touch the touch panel 7 after the operation and determines whether the operation corresponds to an open operation (corresponding to the operation of increasing the parallax) or a close operation (corresponding to the operation of reducing the parallax). Thereafter, when the operation corresponds to the open operation, the parallax adjustment unit 194 increases the parallax of the object contained in the composite image ((a)→(b) of FIG. 36). On the other hand, when the operation corresponds to the close operation, the parallax adjustment unit 194 reduces the parallax of the object contained in the composite image. Consequently, the same functions and advantages as those of the above embodiment can be achieved. It is possible to set a limit to the range of the operation. It is also possible to restrict any operations that may cause the object to extremely protrude or it is possible to limit movement of the object to the range in which two images at a far side or two images at a close side overlap each other as illustrated in (a) and (b) of FIG. 33. It is also possible to restrict operations that may cause contradiction in the horizontal relationship between two images.

In the second embodiment, the imaging unit 2 generates two pieces of image data, in which right-side and left-side portions of respective fields of view overlap each other. However, it is possible to provide only one imaging unit and causes the imaging unit to sequentially capture images in order to generate the two pieces of image data, in which right-side and left-side portions of the respective fields of view overlap each other.

In the second embodiment, the parallax adjustment unit 194 in the shooting mode adjusts the parallax of the object contained in the composite image by changing the trimming area, which is trimmed from each of the right-eye image data and the left-eye image data by the stereoscopic-image generating unit 92, in accordance with the contact trajectory of an external outside on the touch panel 7. However, it is possible to adjust the parallax of the object contained in the composite image by driving the lens driving units 21b and 22b in a synchronized manner and changing the respective fields of view of the lens driving units 21b and 22b.

In the second embodiment, the parallax adjustment unit 194 performs the processes on the live view image displayed by the display unit 6 or on the image data stored in the image-data storage unit 81. However, the display unit 6 may perform the processes on an image that is displayed, as a REC view, by the display unit 6 immediately after the image is captured.

### Third Embodiment

A third embodiment will be explained below. A display apparatus according to the third embodiment is different from those of the above embodiments in that a touch panel and a control unit are configured differently. In addition, the display apparatus according to the third embodiment operates differently from those of the above embodiments. Therefore, in the following, the configurations of the touch panel and the control unit of the display apparatus according to the third embodiment will be explained first, and thereafter, the operation of the display apparatus of the third embodiment will be explained. In the drawings, the same components are denoted by the same reference numerals.

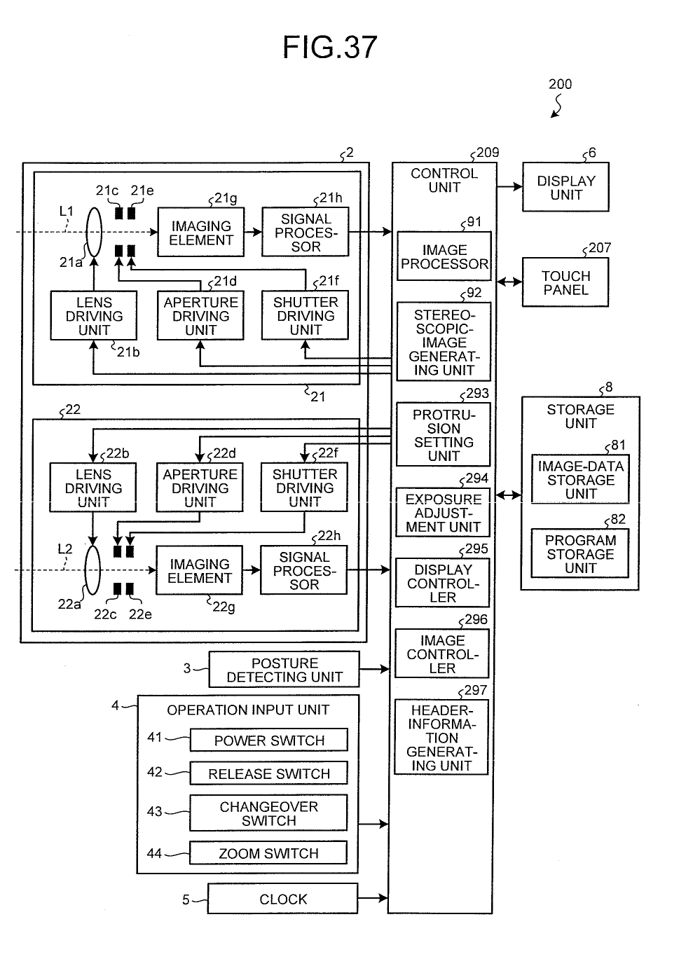

FIG. 37 is a block diagram of a configuration of the display apparatus according to the third embodiment of the present invention. As illustrated in FIG. 37, a display apparatus 200 includes the imaging unit 2, the posture detecting unit 3, the operation input unit 4, the clock 5, the display unit 6, a touch panel 207, the storage unit 8, and a control unit 209.

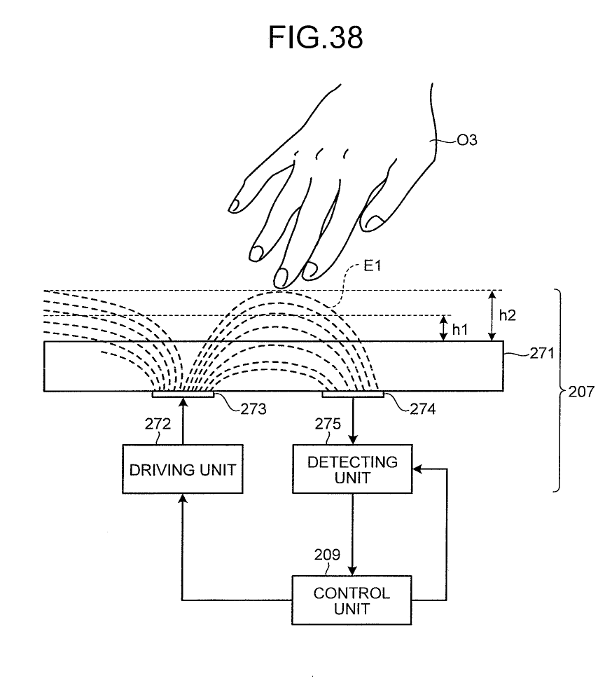

FIG. 38 is a schematic diagram of a configuration of the touch panel 207. As illustrated in FIG. 38, the touch panel 207 includes a front panel 271, a driving unit 272, a driving electrode 273, a receiving electrode 274, and a detecting unit 275.

The front panel 271 has a predetermined thickness, is in the form of a rectangle when viewed two-dimensionally, and is made of glass or polyethylene terephthalate (PET). The driving unit 272 outputs a drive pulse (the applied voltage of, for example, 5V) to the driving electrode 273 in order to generate capacitance between the driving electrode 273 and the receiving electrode 274.

The driving electrode 273 and the receiving electrode 274 are formed as indium tin oxide (ITO) electrodes and alternately arranged on the bottom surface of the front panel 271 at a pitch of 5 mm.

The detecting unit 275 includes a capacitance sensor. When the finger O3 of a user approaches an electric field E1, the detecting unit 275 detects a value of about 1 pF as a small change in the capacitance between the driving electrode 273 and the receiving electrode 274, e.g., as a change that occurs when the finger O3 comes into contact with (touches) the front panel 271. The detecting unit 275 is disclosed in, for example, U.S. Pat. No. 7,148,704. With this technology, the detecting unit 275 can detect a small change in the capacitance between the driving electrode 273 and the receiving electrode 274 before the finger O3 touches the front panel 271. Specifically, as illustrated in FIG. 38, the detecting unit 275 can detect a change in the capacitance between the driving electrode 273 and the receiving electrode 274 when an object moves between two positions at a small distance from each other as in the case where, for example, the finger O3 moves between the position at a distance h1 (e.g., 0.5 cm) and the position at a distance h2 (e.g., 1 cm).

The touch panel 207 configured as above is arranged on the display screen of the display unit 6, detects an area in which an external object approaches the display screen and a distance between the object and the display screen of the display unit 6, and receives input of a signal corresponding to the detection result. Specifically, the touch panel 207 detects a change area where the capacitance changes because of a change in the electric field E1 near the display screen before the user touches the screen of the touch panel 207, and detects a distance corresponding to the amount of change in the capacitance, on the basis of a 2D image or a 3D image displayed by the display unit 6. Thereafter, the touch panel 207 receives input of an operation signal corresponding to the change area and the distance. In the third embodiment, it is explained, as an example, that the touch panel 207 is a capacitive touch panel. However, the touch panel 207 may be an optical touch panel or an infrared touch panel.

The control unit 209 is realized by a CPU or the like. The control unit 209 reads and executes programs stored in the program storage unit 82 of the storage unit 8 in accordance with an operation signal or the like received from the operation input unit 4 and the touch panel 207 and sends instructions or data to each unit of the display apparatus 200 to thereby control the overall operation of the display apparatus 200.

The detailed configuration of the control unit 209 will be explained below. The control unit 209 includes the image processor 91, the stereoscopic-image generating unit 92, a protrusion setting unit 293, an exposure adjustment unit 294, a display controller 295, an image controller 296, and a header-information generating unit 297.

The protrusion setting unit 293 sets, for the 3D image displayed by the display unit 6, a distance (hereinafter, a “protrusion distance”) by which the 3D image virtually protrudes in the direction perpendicular to the display screen of the display unit 6, in accordance with a signal that the touch panel 207 receives in a predetermined area. Specifically, the protrusion setting unit 293 sets the protrusion distance of the 3D image by chaining a trimming area, which is trimmed from each of the left-eye image data and the right-eye image data by the stereoscopic-image generating unit 92, in accordance with a signal that the touch panel 207 receives in a predetermined area. Furthermore, the protrusion setting unit 293 sets the protrusion distance of the 3D image by gradually changing the trimming area, which is trimmed from each of the left-eye image data and the right-eye image data by the stereoscopic-image generating unit 92, in the direction in which the parallax of an object contained in each of the left-eye image data and the right-eye image data is reduced, in accordance with a signal that the touch panel 207 receives in a predetermined area. Moreover, the protrusion setting unit 293 sets, for a plurality of three-dimensional operation images displayed by the display unit 6, the protrusion distance of a three-dimensional operation image (hereinafter, described as a “3D operation image”) that is specified by a signal received by the touch panel 207. In the third embodiment, the protrusion setting unit 293 may adjust a receding distance (a distance in the depth direction) by which the 3D image virtually recedes in the direction perpendicular to the display screen of the display unit 6, in accordance with a signal that the touch panel 207 receives in a predetermined area.

The exposure adjustment unit 294 adjusts the exposure of the imaging unit 2 for the 3D image displayed by the display unit 6, in accordance with a signal received by the touch panel 207. Specifically, the exposure adjustment unit 294 adjusts the exposure of the imaging unit 2 by adjusting setting values of the apertures 21c and 22c by driving the aperture driving units 21d and 22d in accordance with the signal received by the touch panel 207.

The display controller 295 causes the display unit 6 to display a 3D image or a 2D image. Specifically, when causing the display unit 6 to display a 3D image, the display controller 295 outputs, to the display unit 6, a 3D image, in which the left-eye image and the right-eye image of the 3D image generated by the stereoscopic-image generating unit 92 are alternately aligned one pixel by one pixel in the horizontal direction of the display screen of the display unit 6. When causing the display unit 6 to display a 2D image, the display controller 295 changes the power supply to the parallax barrier 63 from the ON state to the OFF state in order to switch the parallax barrier 63 of the display unit 6 from the light-blocking state to the transmissive state and outputs only one of the left-eye image and the right-eye image to the display panel 62. The display controller 295 also causes the display unit 6 to display a 3D image and/or a 3D operation image that is set by the protrusion setting unit 293. The display controller 295 also causes the display unit 6 to display a 3D image that is adjusted by the exposure adjustment unit 294.

The image controller 296 changes a three-dimensional display mode of an image displayed by the display unit 6, in accordance with a change in the display of the 3D operation image. Specifically, the image controller 296 changes the protrusion distance of the 3D image in accordance with the 3D operation image, in which the protrusion distance is changed in accordance with a signal received by the touch panel 207, with respect to the 3D operation image displayed in a predetermined area of the display unit 6.

The header-information generating unit 297 generates header information on the protrusion distance of the 3D image set by the protrusion setting unit 293 and stores the header information in the image-data storage unit 81 in association with the image data generated by the imaging unit 2.

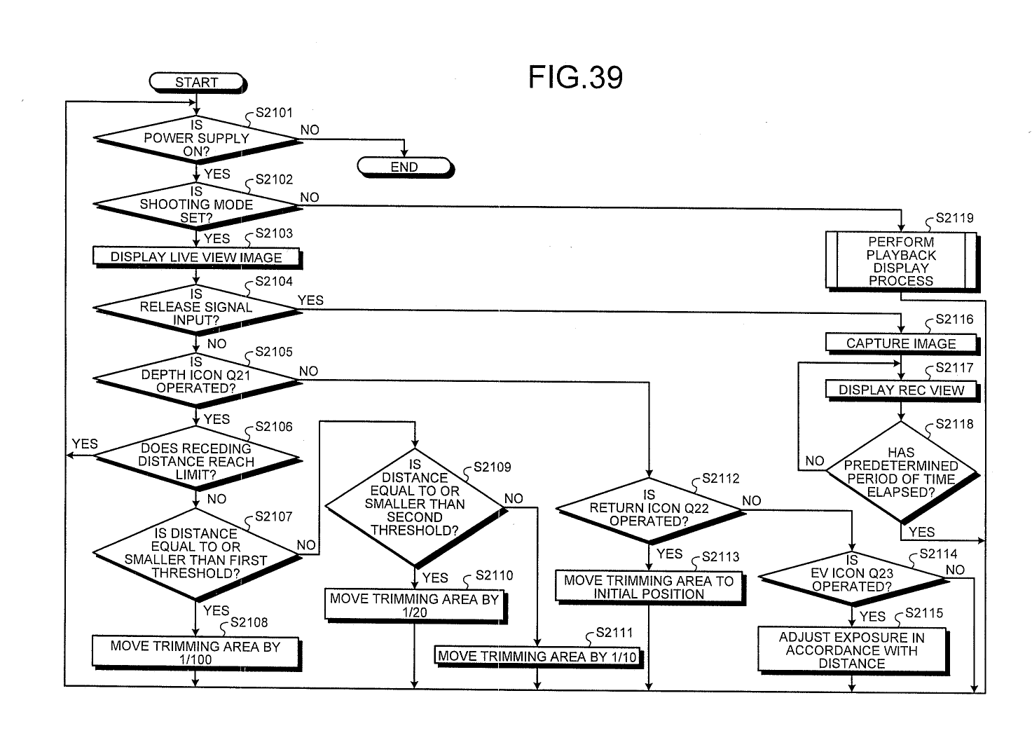

A process performed by the display apparatus 200 according to the third embodiment will be explained below. FIG. 39 is a flowchart of an overview of the process performed by the display apparatus 200.

In FIG. 39, the control unit 209 determines whether the power supply to the display apparatus 200 is on (Step S2101). When the power supply to the display apparatus 200 is on (YES at Step S2101), the display apparatus 200 goes to Step S2102. On the other hand, when the power supply to the display apparatus 200 is not on (NO at Step S2101), the display apparatus 200 ends the process.

The control unit 209 determines whether the display apparatus 200 is set to a shooting mode (Step S2102). When the display apparatus 200 is set to the shooting mode (YES at Step S2102), the display apparatus 200 goes to Step S2103 to be described below. On the other hand, when the display apparatus 200 is not set to the shooting mode (NO at Step S2102), the display apparatus 200 goes to Step S2119 to be described below.

A case will be explained below where the display apparatus 200 is set to the shooting mode (YES at Step S2102). In this case, the display controller 295 causes the display unit 6 to display a live view image of a 3D image corresponding to pieces of image data that the imaging unit 2 has sequentially generated at predetermined small time intervals (Step S2103).

The control unit 209 determines whether a user operates the release switch 42 and a release signal for giving an instruction to capture an image is input (Step S2104). When the release signal for giving the instruction to capture an image is input (YES at Step S2104), the display apparatus 200 goes to Step S2116. On the other hand, when the release signal for giving the instruction to capture an image is not input (NO at Step S2104), the display apparatus 200 goes to Step S2105.

A case will be explained below where the release signal for giving the instruction to capture an image is not input (NO at Step S2104). In this case, the control unit 209 determines whether a depth icon Q21 is operated (Step S2105). When the depth icon Q21 is operated (YES at Step S2105), the display apparatus 200 goes to Step S2106 to be described below. On the other hand, when the depth icon Q21 is not operated (NO at Step S2105), the display apparatus 200 goes to Step S2112 to be described below.

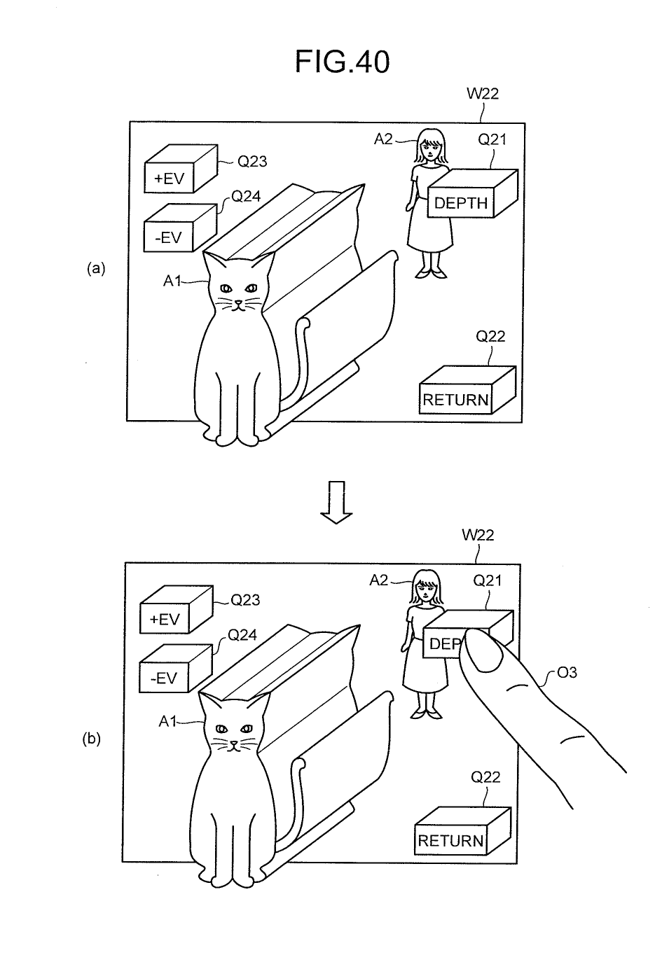

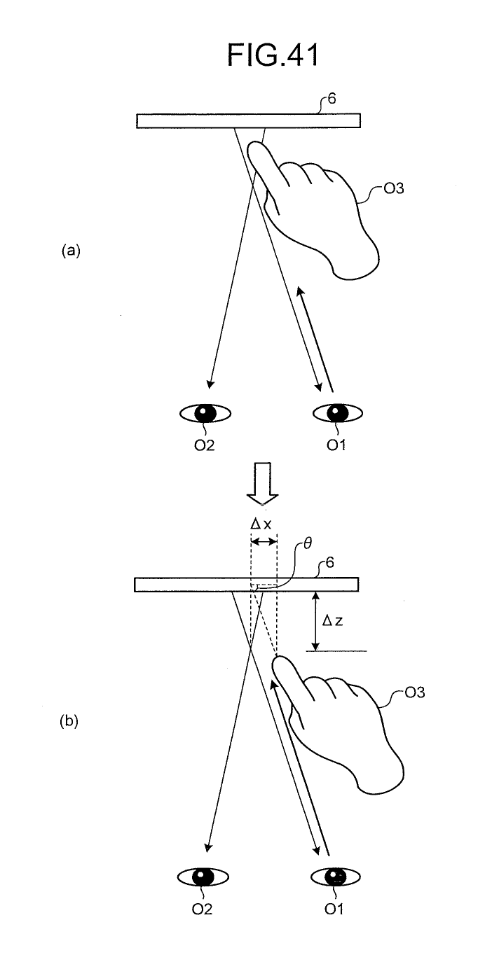

FIG. 40 is a schematic diagram explaining an operation of icons arranged in a virtual 3D image that is displayed by the display unit for viewing by a user. As illustrated in FIG. 40, the control unit 209 determines whether the depth icon Q21, which is arranged in an image W22 displayed by the display unit 6 and used for inputting an instruction signal for giving an instruction to set the protrusion distance of a 3D image, is operated. In this case, the touch panel 207 detects an area in which the user's finger O3 approaches from the outside and a distance between the display screen of the display unit 6 and the finger O3, and thereafter receives and outputs a signal corresponding to the detection result to the control unit 209 ((a)→(b) of FIG. 40). As illustrated in (a) of FIG. 41, when the user operates the 3D image displayed by the display unit 6, there may be a case where the finger O3 comes to a position between the display unit 6 and the right eye O1 of the user and the user may have difficulty in recognizing the 3D image and fail to perform desired operation.

As described above, in the three-dimensional display that is perceived as a 3D image by the user viewing different images by right and left eyes, if only one image is blocked, the user cannot have correct stereoscopy. That is, in the state illustrated in (a) of FIG. 41, the user cannot correctly check a change in the 3D image that is displayed three-dimensionally and cannot normally perform operation. Therefore, according to the third embodiment, as illustrated in (b) of FIG. 41, the touch panel 207 detects a detection area by widening the detection area by Δx (Δx=Δz/tan θ) to the right or to the left on the basis of a protrusion distance Δz of the 3D image, e.g., the depth icon Q21. Consequently, the user can check a change in the 3D image by virtually touching the depth icon Q21 that is a 3D image and can normally perform adjustment.

At Step S2106, the control unit 209 determines whether the receding distance of the 3D image being displayed by the display unit 6 reaches a limit. Specifically, the control unit 209 determines that the receding distance of the 3D image reaches the limit when there is no parallax al of the object A1 contained in the image W1, in which the right-eye image WR1 and the left-eye image WL1 are superimposed, as illustrated in FIG. 5. When the receding distance of the 3D image reaches the limit (YES at Step S2106), the display apparatus 200 returns to Step S2101. On the other hand, when the receding distance of the 3D image does not reach the limit (NO at Step S2106), the display apparatus 200 goes to Step S2107.

The control unit 209 determines whether the distance corresponding to the amount of change in the capacitance detected by the touch panel 207 is equal to or smaller than a first threshold (Step S2107). Specifically, the control unit 209 determines whether the amount of change in the capacitance detected by the touch panel 207 is 0.2 pF or smaller. When the distance corresponding to the amount of change in the capacitance detected by the touch panel 207 is equal to or smaller than a first threshold (YES at Step S2107), the protrusion setting unit 293 moves the trimming area, which is trimmed from the right-eye image data by the stereoscopic-image generating unit 92, by 1/100 (Step S2108). Then, the display apparatus 200 returns to Step S2101.

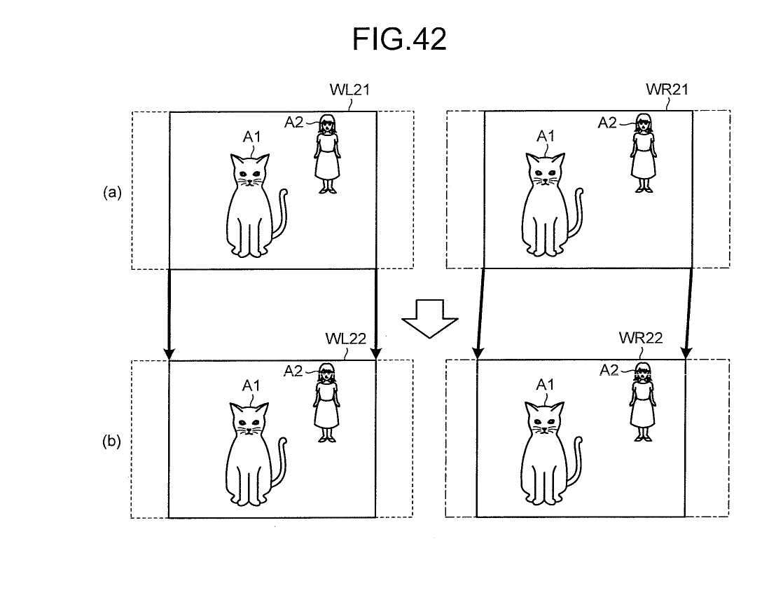

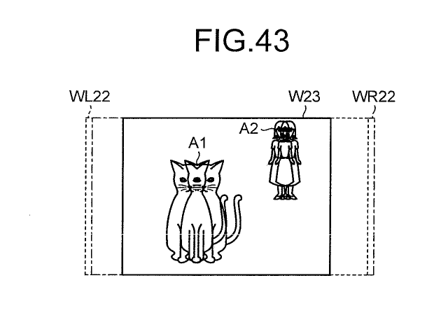

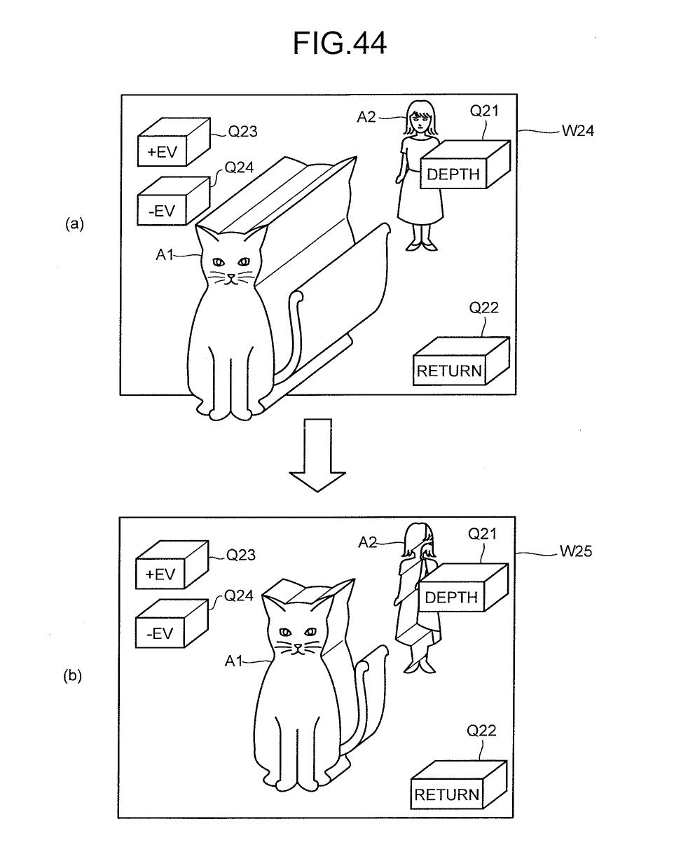

FIG. 42 is a schematic diagram illustrating an overview of a process performed by the protrusion setting unit 293. In FIG. 42, an image WR21 in (a) of FIG. 42 and an image WR22 in (b) of FIG. 42 are right-eye images that the stereoscopic-image generating unit 92 has trimmed at a predetermined vertical-to-horizontal ratio from the right-eye image data generated by the first imaging unit 21. An image WL21 in (a) of FIG. 42 and an image WL22 in (b) of FIG. 42 are left-eye images that the stereoscopic-image generating unit 92 has trimmed at a predetermined vertical-to-horizontal ratio from the left-eye image data generated by the second imaging unit 22. An image W23 in FIG. 43 is an example of an image in which the right-eye image and the left-eye image, for each of which the protrusion setting unit 293 sets the area to be trimmed by the stereoscopic-image generating unit 92, are virtually overlapped with each other. FIG. 44 is a diagram of an example of virtual 3D images that are set by the protrusion setting unit 293 for viewing by a user. In FIG. 44, an image W25 in (a) of FIG. 44 is a 3D image obtained before the protrusion setting unit 293 performs the setting and an image W25 in (b) of FIG. 44 is a 3D image obtained after the protrusion setting unit 293 performs the setting. In FIGS. 42 and 43, dashed lines and chain lines indicate image areas corresponding to image data generated by the first imaging unit 21 or the second imaging unit 22.

As illustrated in FIG. 42, the protrusion setting unit 293 sets the protrusion distance of the 3D image displayed by the display unit 6 by changing a right-eye image trimming area and a left-eye image trimming area, which are generated by trimming the right-eye image data and the left-eye image data by the stereoscopic-image generating unit 92, in accordance with a signal received in an area of the depth icon Q21 by the touch panel 207. Specifically, when causing the object A1 that is virtually protruding in the direction perpendicular to the display screen of the display unit 6 to recede toward the display screen side of the display unit 6, the protrusion setting unit 293 moves the trimming area of the right-eye image data, which is trimmed by the stereoscopic-image generating unit 92, by 1/100 ((a)→(b) of FIG. 42) in order to reduce the parallax of the object A1 contained in the right-eye image WR22 and the left-eye image WL22 (the degree of overlap between the areas) (see the image W23 in FIG. 43), thereby setting the protrusion distance of the object A1 ((a)→(b) of FIG. 44). Besides, the protrusion setting unit 293 sets the protrusion distance of the depth icon Q21 (3D operation image) displayed by the display unit 6, in accordance with a signal received by the touch panel 207 ((a)→(b) of FIG. 44). Specifically, the protrusion setting unit 293 sets the protrusion distance of the depth icon Q21 in accordance with the amount (a distance) by which the user virtually pushes the depth icon Q21 backward.

As described above, the protrusion setting unit 293 changes the trimming areas of the right-eye image and the left-eye image, which are generated by trimming the right-eye image data and the left-eye image data by the stereoscopic-image generating unit 92, in accordance with a signal received in the area of the depth icon Q21 by the touch panel 207, thereby setting the protrusion distance of the 3D image. Thereafter, the display controller 295 causes the display unit 6 to display the 3D image or the 3D operation image set by the protrusion setting unit 293. Therefore, the user can normally check and adjust a change in the protrusion distance of the 3D image while virtually touching the depth icon Q21 provided in the 3D image arranged by the display unit 6. In FIG. 42, the protrusion setting unit 293 moves and changes only the trimming area of the right-eye image. However, it is possible to set the protrusion distance of the 3D image by moving and changing the trimming areas of both of the right-eye image and the left-eye image while synchronizing the right-eye image and the left-eye image. Furthermore, the protrusion setting unit 293 may set the protrusion distance of the 3D image by changing only the trimming area of the left-eye image.

Referring back to FIG. 39, a case at Step S2107 will be explained below where the distance corresponding to the amount of change in the capacitance detected by the touch panel 207 is not equal to or smaller than the first threshold (NO at Step S2107). In this case, the control unit 209 determines whether the distance corresponding to the amount of change in the capacitance detected by the touch panel 207 is equal to or smaller than a second threshold (Step S2109). Specifically, the control unit 209 determines whether the amount of change in the capacitance detected by the touch panel 207 is 0.5 pF or smaller. When the distance corresponding to the amount of change in the capacitance detected by the touch panel 207 is equal to or smaller than the second threshold (YES at Step S2109), the protrusion setting unit 293 moves the trimming area, which is trimmed from the right-eye image data by the stereoscopic-image generating unit 92, by 1/20 (Step S2110). Then, the display apparatus 200 returns to Step S2101.

On the other hand, when the distance corresponding to the amount of change in the capacitance detected by the touch panel 207 is not equal to or smaller than the second threshold (NO at Step S2109), the protrusion setting unit 293 moves the trimming area, which is trimmed from the right-eye image data by the stereoscopic-image generating unit 92, by 1/10 (Step S2111). Then, the display apparatus 200 returns to Step S2101.

A case at Step S2105 will be explained below where the depth icon Q21 is not operated (NO at Step S2105). In this case, the control unit 209 determines whether a return icon Q22 is operated (Step S2112). Specifically, as illustrated in FIG. 40, the control unit 209 determines whether the return icon Q22, which is arranged in the image W22 displayed by the display unit 6 and used for inputting an instruction signal for returning the protrusion distance of the 3D image to the initial state, is operated. In this case, the control unit 209 determines that the second imaging unit 22 is operated when the capacitance detected by the touch panel 207 changes. The initial position is a position of the trimming area of each of the right-eye image and the left-eye image with which the protrusion distance of the 3D image becomes the greatest. Specifically, the initial position is a position of the trimming area at which the parallax of the object A1 contained in each of the right-eye image and the left-eye image generated by the stereoscopic-image generating unit 92 becomes the greatest (see FIG. 5). When the return icon Q22 is operated (YES at Step S2112), the protrusion setting unit 293 returns the area trimmed from the right-eye image data by the stereoscopic-image generating unit 92 to the initial position (Step S2113), and the display apparatus 200 returns to Step S2101.

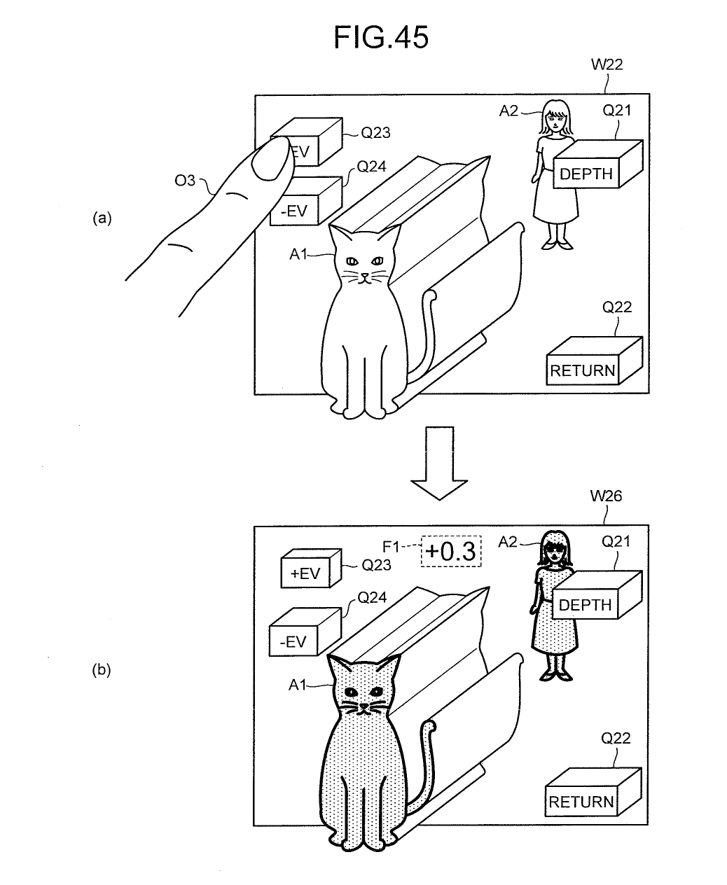

A case at Step S2112 will be explained below where the return icon Q22 is not operated (NO at Step S2112). In this case, the control unit 209 determines whether an EV (exposure) icon Q23 is operated (Step S2114). Specifically, as illustrated in FIG. 40, the control unit 209 determines whether the EV icon Q23, which is arranged in the image W22 displayed by the display unit 6 and used for inputting an instruction signal for adjusting the exposure of the imaging unit 2, is operated. When the EV icon Q23 is not operated (NO at Step S2114), the display apparatus 200 returns to Step S2101. On the other hand, when the EV icon Q23 is operated (YES at Step S2114), the exposure adjustment unit 294 adjusts the exposure of the imaging unit 2 in accordance with the distance corresponding to the amount of change in the capacitance detected by the touch panel 207 (Step S2115), and thereafter, the display apparatus 200 returns to Step S2101. Specifically, as illustrated in FIG. 45, the exposure adjustment unit 294 adjusts the exposure of the imaging unit 2 in accordance with the distance corresponding to the amount of change in the capacitance detected by the touch panel 207 ((a)→(b) of FIG. 45). At this time, as illustrated in FIG. 45, the display controller 295 may display a focal value F1 (+0.3) on the screen of the display unit 6. Accordingly, the user can easily recognize the amount of change that occurs when the user virtually touches the EV icon Q23 being the 3D image.

A case at Step S2104 will be explained below where the user operates the release switch 42 and the release signal for giving the instruction to capture an image is input (YES at Step S2104). In this case, the imaging unit 2 captures the image that is being displayed on the display unit 6 and stores image data of the captured image in the image-data storage unit 81 of the storage unit 8 (Step S2116).

The display controller 295 causes the display unit 6 to display a REC view being a 3D image corresponding to the image data captured by the imaging unit 2 (Step S2117). Accordingly, the user can check the degree of depth of the captured image.

Thereafter, the control unit 209 determines whether a predetermined period of time has elapsed since the display of the REC view of the 3D image by the display unit 6 (Step S2118). Specifically, the control unit 209 determines whether 1 minute has elapsed since the display of the REC view of the 3D image by the display unit 6. As a result of the determination by the control unit 209, when the predetermined period of time has not elapsed since the display of the REC view of the 3D image by the display unit 6 (NO at Step S2118), the display apparatus 200 returns to Step S2117. On the other hand, as a result of the determination by the control unit 209, when the predetermined period of time has elapsed since the display of the REC view of the 3D image by the display unit 6 (YES at Step S2118), the display apparatus 200 returns to Step S2101.

A case at Step S2102 will be explained below where the display apparatus 200 is not set to the shooting mode (NO at Step S2102). In this case, the display apparatus 200 performs the playback display process for displaying the captured image data on the display unit 6 (Step S2119), and the display apparatus 200 returns to Step S2101.

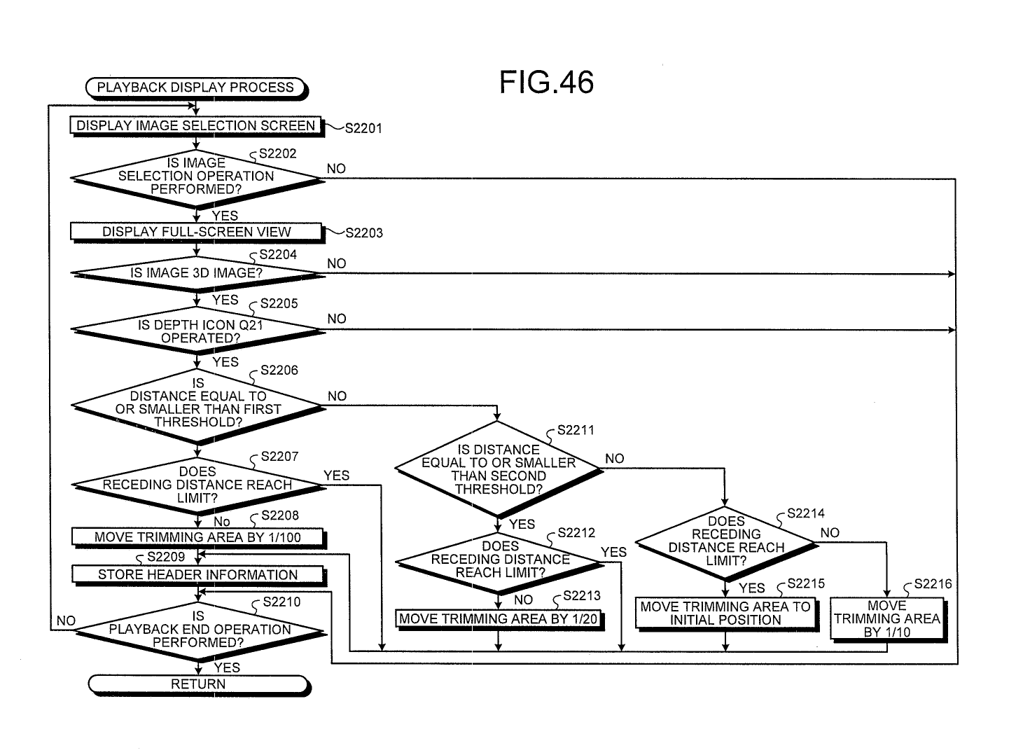

The playback display process performed at Step S2119 in FIG. 39 will be explained below. FIG. 46 is a flowchart of an overview of the playback display process.

In FIG. 46, the display controller 295 causes the display unit 6 to display an image selection screen, in which pieces of image data stored in the image-data storage unit 81 are collectively displayed (Step S2201).

The control unit 209 determines whether the user operates the touch panel 207 and selects any image from the image selection screen displayed by the display unit 6 (Step S2202). When the user selects any image from the image selection screen (YES at Step S2202), the display apparatus 200 goes to Step S2203 to be described below. On the other hand, when the user does not select any image from the image selection screen (NO at Step S2202), the display apparatus 200 goes to Step S2210 to be described below.

A case will be explained below where the user selects any image from the image selection screen (YES at Step S2202). In this case, the display controller 295 causes the display unit 6 to display a full-screen view of the image selected by the user (Step S2203), and the control unit 209 determines whether the image displayed by the display unit 6 is a 3D image (Step S2204). Specifically, the control unit 209 refers to the header information of the image displayed by the display unit 6 and determines whether a 3D image is displayed. When the image displayed by the display unit 6 is the 3D image (YES at Step S2204), the display apparatus 200 goes to Step S2205. On the other hand, when the image displayed by the display unit 6 is not the 3D image (NO at Step S2204), the display apparatus 200 goes to Step S2210.

At Step S2205, the control unit 209 determines whether the depth icon Q21 is operated. When the depth icon Q21 is not operated (NO at Step S2205), the display apparatus 200 goes to Step S2210. On the other hand, when the depth icon Q21 is operated (YES at Step S2205), the display apparatus 200 goes to Step S2206.

At Step S2206, the control unit 209 determines whether the distance corresponding to the amount of change in the capacitance detected by the touch panel 207 is equal to or smaller than a first threshold (Step S2206). When the distance corresponding to the amount of change in the capacitance detected by the touch panel 207 is equal to or smaller than the first threshold (YES Step S2206), the control unit 209 determines whether the receding distance of the 3D image being displayed by the display unit 6 reaches the limit (Step S2207). When the receding distance of the 3D image does not reach the limit (NO at Step S2207), the protrusion setting unit 293 moves the trimming area, which is trimmed from the right-eye image by the stereoscopic-image generating unit 92, by 1/100 (Step S2208). Then, the display apparatus 200 goes to Step S2209.

On the other hand, when the receding distance of the 3D image reaches the limit (YES at Step S2207), the display apparatus 200 goes to Step S2209.

At Step S2209, the header-information generating unit 297 generates, as the header information of the 3D image data, the protrusion distance of the 3D image being displayed by the display unit 6 and stores the generated header information in the image-data storage unit 81 in association with the 3D image data.

Subsequently, the control unit 209 determines whether the playback end operation is performed (Step S2210). Specifically, the control unit 209 determines whether the user operates the changeover switch 43 and an instruction signal for ending the playback of an image is input. When the playback end operation is not performed (NO at Step S2210), the display apparatus 200 returns to Step S2201. On the other hand, when the playback end operation is performed (YES at Step S2210), the display apparatus 200 returns to the main routine in FIG. 39.

A case at Step S2206 will be explained where the distance corresponding to the amount of change in the capacitance detected by the touch panel 207 is not equal to or smaller than the first threshold (NO at Step S2206). In this case, the control unit 209 determines whether the distance corresponding to the amount of change in the capacitance detected by the touch panel 207 is equal to or smaller than a second threshold (Step S2211). When the distance corresponding to the amount of change in the capacitance detected by the touch panel 207 is equal to or smaller than the second threshold (YES at Step S2211), the control unit 209 determines whether the receding distance of the 3D image being displayed by the display unit 6 reaches the limit (Step S2212). When the receding distance of the 3D image reaches the limit (YES at Step S2212), the display apparatus 200 goes to Step S2209. On the other hand, when the receding distance of the 3D image does not reach the limit (NO at Step S2212), the protrusion setting unit 293 moves the trimming area, which is trimmed from the right-eye image data by the stereoscopic-image generating unit 92, by 1/20 (Step S2213). Thereafter, the display apparatus 200 goes to Step S2209.

A case at Step S2211 will be explained below where the distance corresponding to the amount of change in the capacitance detected by the touch panel 207 is not equal to or smaller than the second threshold (NO at Step S2211). In this case, the control unit 209 determines whether the receding distance of the 3D image being displayed by the display unit 6 reaches the limit (Step S2214). When the receding distance of the 3D image reaches the limit (YES at Step S2214), the protrusion setting unit 293 returns the trimming area, which is trimmed from the right-eye image data by the stereoscopic-image generating unit 92, to the initial position (Step S2215). Then, the display apparatus 200 goes to Step S2209.

On the other hand, when the receding distance of the 3D image does not reach the limit (No at Step S2214), the protrusion setting unit 293 moves the trimming area, which is trimmed from the right-eye image data by the stereoscopic-image generating unit 92, by 1/10 (Step S2216). Thereafter, the display apparatus 200 goes to Step S2209.

According to the third embodiment of the present invention described above, the touch panel 207 detects an area, in which an external object approaches the touch panel, detects a distance between the object and the display screen of the display unit 6, and receives a signal corresponding to the detection result; the protrusion setting unit 293 sets a protrusion distance of a 3D image displayed by the display unit 6 in accordance with a signal that the touch panel 207 receives in a predetermined area; and the display controller 295 causes the display unit 6 to display the 3D image set by the protrusion setting unit 293. Therefore, the user can normally check and adjust a change in the 3D image while virtually touching the first imaging unit 21 being a 3D image.

### Modification of Third Embodiment

In the third embodiment described above, the imaging unit 2 generates two pieces of image data, in which right-side and left-side portions of respective fields of view overlap each other. However, for example, it is possible to provide only one imaging unit and cause the imaging unit 2 to sequentially capture images to generate the two pieces of image data, in which right-side and left-side portions of the respective fields of view overlap each other.

In the third embodiment, the imaging unit 2 generates the two pieces of image data, in which right-side and left-side portions of the respective fields of view overlap each other. However, for example, it is possible to provide only one imaging element, forms two images in the imaging area of the imaging element by focusing light by two optical systems, and uses two pieces of image data corresponding to the two images in order to generate the two pieces of image data, in which right-side and left-side portions of the respective fields of view overlap each other.

In the third embodiment, the posture detecting unit 3 detects the posture of the display apparatus 200. However, for example, it is possible to detect acceleration that occurs when a user taps the display screen of the display unit 6, receive an operation signal of the tap operation for switching between various shooting modes or various settings of the display apparatus 200, and output the operation signal to the control unit 209.

In the third embodiment, when the depth icon Q21 arranged in the 3D image displayed by the display unit 6 is operated, the protrusion setting unit 293 sets the protrusion distance of the 3D image by changing the trimming area, which is trimmed from each of the right-eye image data and the left-eye image data generated by the stereoscopic-image generating unit 92. However, it is possible to set the protrusion distance of the 3D image by changing the field of view of each of the first imaging unit 21 and the second imaging unit 22 by driving the lens driving units 21b and 22b in a synchronized manner.

In the third embodiment, the protrusion setting unit 293 gradually changes the trimming area, which is trimmed from each of the right-eye image data and the left-eye image data by the stereoscopic-image generating unit 92, when the depth icon Q21 arranged in the 3D image displayed by the display unit 6 is operated. However, for example, it is possible to sequentially change the trimming area in accordance with an input signal received by the touch panel 207.

In the third embodiment, the protrusion distance of the 3D image is changed when the user operates the depth icon Q21. However, it is possible to change the protrusion distance of the 3D image when the user operates the object A1 contained in the 3D image. In this case, the protrusion setting unit 293 may set the protrusion distance of the 3D image by adjusting the degree of overlap (parallax) of the object, which is specified by a signal received by the touch panel 207, between the righty-eye image and the left-eye image.

In the third embodiment, the detecting unit 275 of the touch panel 207 detects the distance corresponding to the change in the capacitance. However, it is possible to provide an optical sensor that detects light reflected from the outside of the display unit 6 after the illumination light is emitted from a back light 261, and cause the protrusion setting unit 293 to set the protrusion distance of the 3D image in accordance with a detection time of the optical sensor. In this case, the touch panel may be a photoelectric touch panel.

In the third embodiment, the detecting unit 275 of the touch panel 207 detects the distance corresponding to the change in the capacitance. However, it is possible to provide an infrared sensor such that infrared light is applied from the infrared sensor to the front panel 271 and the protrusion setting unit 293 sets the protrusion distance of the 3D image in accordance with the dimensions of the area of the front panel 271 touched by the user. In this case, the touch panel may be an infrared touch panel.

In the third embodiment, the protrusion setting unit 293 performs the processes on the live view image displayed by the display unit 6 or the image data stored in the image-data storage unit 81. However, it is possible to perform the processes on the image that is displayed, as a REC view, by the display unit 6 immediately after the image is captured.

In the third embodiment, the exposure adjustment unit 294 adjusts the exposure of the imaging unit 2 when the EV icon Q23 arranged in the image W22 displayed by the display unit 6 is operated. However, it is possible to provide a zoom icon in the image W2 and change a zoom factor of the imaging unit 2 when the user operates the zoom icon. Furthermore, it is possible to provide, in the image W2 displayed by the display unit 6, a mode change icon or the like for switching between shooting modes.

### Other Embodiment

In the above embodiments of the present invention, the display unit uses a parallax barrier system. However, it is satisfactory if a 3D image can be viewed stereoscopically, and a lenticular system may be used.

In the above embodiments, the image processor and the control unit are integrally configured. However, it is possible to separately arrange the image processor (image processing engine) in the imaging device and to cause the control unit to send various instruction or data to the image processor. It is of course possible to provide the image processor in two or more imaging devices.

In the above embodiments, the display unit uses the parallax barrier system. However, it is satisfactory if a 3D image can be viewed stereoscopically, and it is possible to employ the lenticular lens system, in which a lens sheet disposed with a lenticular lens is disposed on the top surface of a display panel.

In the above embodiments, the display apparatus 1 is explained as a digital stereo camera. However, the present invention can be applied to various electronic equipments having shooting functions and displaying functions, such as digital video cameras or mobile phones equipped with cameras.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a display unit that displays a three-dimensional image that is generated by combining two pieces of image data;
an area selecting-setting unit that selects an adjustment area whose offset distance is adjusted, the offset distance being a virtual distance from a display screen of the display unit in a direction perpendicular to the display screen in the three-dimensional image displayed by the display unit;
an input unit that receives input of a change instruction signal for giving an instruction to change the offset distance of the adjustment area selected by the area selecting-setting unit;
an offset-distance adjustment unit that adjusts the offset distance of the adjustment area in accordance with the change instruction signal received by the input unit; and
a display controller that causes the display unit to display a three-dimensional image by using the two pieces of image data, in each of which the offset distance of the adjustment area is adjusted by the offset-distance adjustment unit.

2. The display apparatus according to claim 1, wherein
the offset-distance adjustment unit adjusts the offset distance by adjusting a parallax of the adjustment area.

3. The display apparatus according to claim 2, further comprising:
a trimming unit that generates a trimming image by trimming the adjustment area, which is selected by the area selecting-setting unit, from each piece of the image data;
a scaling unit that generates enlarged trimming images by enlarging the trimming images generated by the trimming unit or generates reduced trimming images by reducing the trimming images generated by the trimming unit; and
a composite-image generating unit that generates composite images, in each of which the corresponding enlarged trimming image or the corresponding reduced trimming image generated by the scaling unit is superimposed on the adjustment area, wherein
the display controller causes the display unit to display a three-dimensional image by using the composite images generated by the composite-image generating unit.

4. The display apparatus according to claim 3, wherein
the scaling unit enlarges or reduces the trimming images on the basis of the parallax of the adjustment area and the offset distance of the adjustment area.

5. The display apparatus according to claim 4, wherein
the input unit receives input of a specification signal for specifying an object in the three-dimensional image,
the area selecting-setting unit selects, as the adjustment area, an area that contains the object specified by the specification signal received by the input unit and that is contained in each of the two pieces of image data,
the offset-distance adjustment unit adjusts a parallax of the specified object contained in each of the two pieces of the image data, and
the display controller causes the display unit to display a three-dimensional image by using the two pieces of image data, in each of which the parallax of the specified object is adjusted by the offset-distance adjustment unit.

6. The display apparatus according to claim 5, further comprising:
an imaging unit that captures images at different positions and generates two pieces of image data, in which right-side and left-side portions of respective fields of view overlap each other; and
a stereoscopic-image generating unit that generates the three-dimensional image by trimming, at a predetermined vertical-to-horizontal ratio, each of two images corresponding to the two pieces of the image data generated by the imaging unit, wherein
the display controller outputs the three-dimensional image generated by the stereoscopic-image generating unit to the display unit by alternately arranging images, which are trimmed from the two images, one pixel by one pixel in the horizontal direction of the display screen.

7. The display apparatus according to claim 6, wherein
the input unit includes a touch panel for receiving input of a signal corresponding to a contact position of an external object on the touch panel, and
the area selecting-setting unit selects, as the adjustment area, an area that is contained in each of the two pieces of the image data and that contains an object specified by an input signal received by the touch panel.

8. The display apparatus according to claim 7, wherein
the display controller causes the display unit to display a plurality of icons for receiving input of change instruction signals indicating different contents, and
the offset-distance adjustment unit adjusts the parallax of the adjustment area in accordance with a change instruction signal that is received by the touch panel in a contact area corresponding to a display area of each of the icons.

9. A display apparatus comprising:
a display unit that displays a composite image that is obtained by superimposing two pieces of image data, in which right-side and left-side portions of respective fields of view overlap each other;
a touch panel that is arranged on a display screen of the display unit and that is used for receiving input of a signal corresponding to a contact position of an external object on the touch panel;
a parallax adjustment unit that adjusts a parallax of an object contained in the composite image displayed by the display unit, in accordance with a contact trajectory of the object on the touch panel; and
a display controller that causes the display unit to display the composite image adjusted by the parallax adjustment unit.

10. The display apparatus according to claim 9, wherein
the composite image is generated by trimming each of the two pieces of image data and superimposing the trimmed pieces of data with each other, and
the parallax adjustment unit changes an area trimmed from each of the two pieces of image data.

11. The display apparatus according to claim 10, wherein the display controller causes the display unit to display parallax information relating to a parallax of an object contained in the composite image.

12. A display apparatus comprising:
a display unit that displays a three-dimensional image that is generated by combining two pieces of image data, in which right-side and left-side portions of respective fields of view overlap each other;
a touch panel that is arranged on a display screen of the display unit, detects an area in which an external object approaches the display screen and a distance between the object and the display screen, and receives input of a signal corresponding to a detection result;
a protrusion setting unit that sets a protrusion distance, by which the three-dimensional image displayed by the display unit virtually protrudes in a direction perpendicular to the display screen, in accordance with a signal that the touch panel receives in a predetermined area by; and
a display controller that causes the display unit to display the three-dimensional image set by the protrusion setting unit.

13. The display apparatus according to claim 12, further comprising:
an imaging unit that captures images at different positions and generates two pieces of image data, in which right-side and left-side portions of respective fields of view overlap each other; and
a stereoscopic-image generating unit that generates the three-dimensional image by trimming, at a predetermined vertical-to-horizontal ratio, each of two images corresponding to the two pieces of image data generated by the imaging unit, wherein
the protrusion setting unit sets the protrusion distance of the three-dimensional image by changing a trimming area which is trimmed from each of the two pieces of image data by the stereoscopic-image generating unit, and
the display controller outputs images corresponding to the two pieces of image data set by the protrusion setting unit such that the images are alternately aligned one pixel by one pixel in the horizontal direction of the display screen.

14. The display apparatus according to claim 13, wherein
the protrusion setting unit gradually changes the trimming area which is trimmed from each of the two pieces of image data by the stereoscopic-image generating unit in a direction in which a parallax of an object contained in each of the two pieces of image data is reduced, in accordance with a signal received by the touch panel.

15. A display method performed by a display apparatus that includes a display unit for displaying a three-dimensional image that is generated by combining two pieces of image data, the display method comprising:
selecting an adjustment area whose offset distance is adjusted, the offset distance being a virtual distance from a display screen of the display unit in a direction perpendicular to the display screen in the three-dimensional image displayed by the display unit;
receiving input of a change instruction signal for giving an instruction to change the offset distance of the adjustment area;
adjusting the offset distance of the adjustment area in accordance with the change instruction signal; and
causing the display unit to display a three-dimensional image by using the two pieces of image data in which the offset distance of the adjustment area is adjusted.

16. A display method performed by a display apparatus that includes a display unit for displaying a composite image that is obtained by superimposing two pieces of image data, in which right-side and left-side portions of respective fields of view overlap each other, the display method comprising:
receiving input of a signal corresponding to a contact position of an external object;
adjusting a parallax of an object contained in the composite image displayed by the display unit, in accordance with a contact trajectory of the object; and
causing the display unit to display the composite image in which the parallax of the subject is adjusted.

17. A display method performed by a display apparatus that displays a three-dimensional image generated by combining two pieces of image data, in which right-side and left-side portions of respective fields of view overlap each other, the display method comprising;
detecting an area, in which an external object approaches a display screen of the display apparatus, and a distance between the object and the display screen;
receiving input of a signal corresponding to a detection result;
setting a protrusion distance, by which the three-dimensional image virtually protrudes in a direction perpendicular to the display screen, in accordance with the signal; and
causing the display unit to display the three-dimensional image in which the protrusion distance is set.

18. A non-transitory computer-readable storage medium with an executable program stored thereon, wherein the program instructs a processor included in a display apparatus that includes a display unit for displaying a three-dimensional image generated by combining two pieces of image data, in which right-side and left-side portions of respective fields of view overlap each other, to perform:
selecting an adjustment area whose offset distance is adjusted, the offset distance being a virtual distance from a display screen of the display unit in a direction perpendicular to the display screen in the three-dimensional image displayed by the display unit;
receiving input of a change instruction signal for giving an instruction to change the offset distance of the adjustment area;
adjusting the offset distance of the adjustment area in accordance with the change instruction signal; and
causing the display unit to display a three-dimensional image by using the two pieces of image data in which the offset distance of the adjustment area is adjusted.

19. A non-transitory computer-readable storage medium with an executable program stored thereon, wherein the program instructs a processor included in a display apparatus that includes a display unit for displaying a composite image that is obtained by superimposing two pieces of image data, in which right-side and left-side portions of respective fields of view overlap each other, to perform:
receiving input of a signal corresponding to a contact position of an external object;
adjusting a parallax of an object contained in the composite image displayed by the display unit, in accordance with a contact trajectory of the object; and
causing the display unit to display the composite image in which the parallax of the subject is adjusted.

20. A non-transitory computer-readable storage medium with an executable program stored thereon, wherein the program instructs a processor included in a display apparatus that displays a three-dimensional image generated by combining two pieces of image data, in which right-side and left-side portions of respective fields of view overlap each other, to perform:
detecting an area, in which an external object approaches a display screen of the display apparatus, and a distance between the object and the display screen;
receiving input of a signal corresponding to a detection result;
setting a protrusion distance, by which the three-dimensional image virtually protrudes in a direction perpendicular to the display screen, in accordance with the signal; and
causing the display unit to display the three-dimensional image in which the protrusion distance is set.
